(19) United States
(12) Patent Application Publication
(10) Pub. No.: US 2022/0189328 A1
(43) Pub. Date: Jun. 16, 2022

(54) Podport and Associated Podways for Unmanned Arial Vehicles

(71) Applicant: Michael Steward Evans, Los Gatos, CA (US)

(72) Inventor: Michael Steward Evans, Los Gatos, CA (US)

(21) Appl. No.: 17/683,677

(22) Filed: Mar. 1, 2022

Related U.S. Application Data
(63) Continuation-in-part of application No. 16/725,745, filed on Dec. 23, 2019.
(60) Provisional application No. 62/785,088, filed on Dec. 26, 2018.
(60) Provisional application No. 63/155,479, filed on Mar. 2, 2021.

(51) Int. Cl. G08G 9/00; G08G 5/00; G08G 1/097; B60L 53/00; B61L 27/10

(52) U.S. Cl. CPC G08G 9/00; G08G 5/0043; B61L 27/10; B60L 53/00; G08G 1/097

(57) ABSTRACT

A transportation system has transport vehicles with electric motors, pods, being enclosed compartments that accommodate cargo, podports, being exchange stations, charging stations, and a computerized transport control system. An authorized person communicates a request to the computerized transport control system to transport a specific cargo from a first location in the geographic area to a second location in the geographic area, the computerized transport control system defines a journey from the first location to the second location, along a route comprising sequential hops through a series of podports and charging stations. The computerized transport control system manages movement of transport vehicles, exchanges at podports, and charging at charging stations along the defined route, and terminates the journey at the second location where the cargo disembarks.

### CROSS-REFERENCE TO RELATED DOCUMENTS

The present application is a Continuation-in-Part (CIP) of co-pending application Ser. No. 16/725,745 filed Dec. 23, 2019, which claims priority to provisional patent application 62/785,088, filed Dec. 26, 2018, and also claims priority to provisional patent application 63/155,479 filed Mar. 2, 2021. All disclosure of the parent documents is incorporated at least by reference.

### BACKGROUND OF THE INVENTION

### 1. Field of the Invention

The present invention is in the technical area of modular transport apparatus based on Pod units that may be carried by ground vehicles, rail vehicles and unmanned arial vehicles (UAVs), and storage, docking facilities landing stations and charging facilities for such apparatus.

### 2. Discussion of the State of the Art

Pod-based apparatus for transporting passengers and cargo is relatively new in the art, and not many commercial facilities are known. There are, in the current state of the art, UAV taxi systems, for example, which have a passenger pod that may be detached from the UAV, loaded with either passengers of cargo, or both, and then picked up by a UAV to be transported to an end destination. The challenges in many different carriers that may be utilized, how pods may be exchanged between different sorts of carriers, including ground carriers, rail carries and UAVs such as drones are significant, as are how the carriers may be powered, and in the case of battery power, how the carriers may be charged and maintained. The present inventor believes the present disclosure adds unique apparatus and functionality to the existing state of the art in passenger and cargo transport.

### BRIEF SUMMARY OF THE INVENTION

In an embodiment of the present invention a transportation system is provided, comprising a plurality of transport vehicles, each having controllable electric motors and a first attachment interface, a plurality of pods, being enclosed compartments that can accommodate cargo, each pod having a door, a rechargeable battery, and a second attachment interface adapted to attach to the first attachment interface of an individual one of the transport vehicles, a plurality of podports, being exchange stations adapted to attach to and detach pods from individual ones of the transport vehicles, individual ones of the podports located at specific locations in a specific geographic area, a plurality of charging stations located at specific locations within the geographic area, and a computerized transport control system. The system is characterized in that an authorized person communicates a request to the computerized transport control system to transport a specific cargo from a first location in the geographic area to a second location in the geographic area, the computerized transport control system in response defines a journey beginning at the first location and ending at the second location, the definition of the journey including a time for pickup of the specific cargo, a specific pod and transport vehicle assigned for pickup, and a route, the route comprising sequential hops through a series of podports and charging stations, the computerized transport control system managing movement of transport vehicles, exchanges at podports, and charging at charging stations along the defined route, the route ending at the second location where the cargo disembarks, wherein the computerized transport control system terminates the journey.

In one embodiment of the system the cargo comprises passengers or parcels, or both passengers and parcels. Also, in one embodiment the plurality of transport vehicles comprises unmanned arial vehicles (UAVs) and transport chassis, the transport chassis adapted to travel on a roadway or on an overhead railway. In one embodiment, in a journey, the pod is carried for a hop by a drone or by a transport chassis, and the pod is detached from one transport vehicle and attached to a different transport vehicle at individual ones of the podports in the journey. And in one embodiment the computerized transport control system creates a cluster network control (CNC) module unique to each defined journey, and the CNC controls the route for which it is created, retrieves status of the pod as the pod exits each podport and charging station along the route, and communicates completion of the journey to the computerized control system.

In one embodiment, with a pod attached to a transport vehicle, an electrical connection is implemented as well as a physical connection, and the electric motors of the transport vehicle are powered by the pod battery. Also, in one embodiment charging stations are adapted to charge the pod battery. Also, in one embodiment individual ones of the plurality of pods comprise an upper attachment interface adapted to attach to an attachment interface of an unmanned arial vehicle, to be suspended below the unmanned arial vehicle. and a lower attachment interface adapted to attach to an upper attachment interface of a transport chassis adapted to travel on a roadway or on an overhead railway. In one embodiment, in the management of a journey the computerized transport control system communicates with remote data centers, comprising at least a weather bureau that provides up to date local weather information, an emergency center adapted to resolve exceptions, a data analytics center that is adapted to store each completed route for future use and analysis, and a test diagnostics unit adapted to check the system and to fix problems. And in one embodiment the CNC for a defined journey tracks the location of the pod, and as the pod approaches each podport in the journey, the podport is provided with information regarding the pod and the journey, and any defined exchange at the podport, and the podport manages movement of the pod through the podport.

In another aspect of the invention a transportation method is provided, comprising communicating a request by an authorized person to a computerized transport control system to transport a specific cargo from a first location in a geographic area to a second location in the geographic area, defining a journey by the computerized transport control system in response to the request, the journey beginning at a first location in the geographic area and ending at a second location, the definition of the journey including a time for pickup of the specific cargo, a specific pod among a plurality of available pods, a pod being an enclosed compartment that can accommodate cargo, each pod having a door, a rechargeable battery, and a second attachment interface, and transport vehicle assigned for pickup among a plurality of available transport vehicles each having controllable electric motors and a first attachment interface, and a route, the route comprising sequential hops through a series of podports and charging stations, a podport being an exchange station adapted to attach to and detach pods from individual ones of the transport vehicles, individual ones of the podports located at specific locations in a specific geographic area, managing by the computerized transport control system movement of the pod and transport vehicle during the journey, exchanges at podports, and charging at charging stations along the defined route, and terminating the journey at the second location where the cargo disembarks.

In one embodiment of the method the cargo comprises passengers or parcels, or both passengers and parcels, comprising moving the passengers and parcels or both along the route to the second location. Also, in one embodiment the plurality of transport vehicles comprises unmanned arial vehicles (UAVs) and transport chassis, the transport chassis adapted to travel on a roadway or on an overhead railway, comprising managing by the computerized transport control system the movement of the transport vehicle whether UAV of chassis. In one embodiment the method comprises, in a journey, carrying the pod for a hop by the UAV or by a the transport chassis, and detaching the pod from one transport vehicle and attaching the pod to a different transport vehicle at individual ones of the podports in the journey. And in one embodiment the computerized transport control system creates a cluster network control (CNC) module unique to each defined journey, comprising controlling the route by the CNC , retrieving status of the pod as the pod exits each podport and charging station along the route, and communicating completion of the journey to the computerized control system.

In one embodiment the method comprises establishing an electrical connection as well as a physical connection when joining a pod to a transport vehicle, and driving the electric motors of the transport vehicle from the pod battery. In one embodiment the method comprises charging the pod battery by the charging stations. In one embodiment the method comprises attaching pods to UAVs by an upper attachment interface on the pad joining a lower attachment interface on the UAV, and attaching pods to transport chassis by a lower attachment interface on the pod to an upper attachment interface on the transport chassis. In one embodiment the method further comprises communicating by the computerized transport control system with remote data centers, the remote data centers comprising at least a weather bureau that provides up to date local weather information, an emergency center adapted to resolve exceptions, a data analytics center that is adapted to store each completed route for future use and analysis, and a test diagnostics unit adapted to check the system and to fix problems. And in one embodiment the method comprises tracking location of the pod in a defined journey by the CNC, providing information regarding the pod and the journey to a podport as the pod approaches the podport, including any defined exchange at the podport, and managing movement of the pod through the podport.

### BRIEF DESCRIPTION OF THE SEVERAL VIEWS OF THE DRAWINGS

FIG. 1 illustrates attachable pods for air or ground transport in an embodiment of the invention.

FIG. 2 illustrates a podport for dronepods and carpods in an embodiment of the invention.

FIG. 3 illustrates a layout of podports for dronepods and railpods in an embodiment of the invention.

FIG. 4 illustrates dronepods and carpods in a single floor podport in an embodiment of the invention.

FIG. 5 illustrates a system from drone parcel delivery to a full local transport system in an embodiment of the invention.

FIG. 6 illustrates parcel transport via dronepod to a local podport to a carpod in an embodiment of the invention.

FIG. 7 illustrates parcel deliveries in dronepods in an embodiment of the invention.

FIG. 8 illustrates trampods, railpods, and podports for passengers and parcels in an embodiment of the invention.

FIG. 9 illustrates passenger and parcel transport via a main podport in an embodiment of the invention.

FIG. 10 illustrates TSC and CNC control of various transports in an embodiment of the invention.

FIG. 11 illustrates transport system hardware links in an embodiment of the invention.

FIG. 12 illustrates software/firmware and links in an embodiment of the invention.

FIG. 13 illustrates route Setup and termination in transport system control in an embodiment of the invention.

FIG. 14 illustrates cluster network control in an embodiment of the invention.

FIG. 15 is an overview of podports and podchargers in an embodiment of the invention.

FIG. 16 illustrates podport-pod communications in an embodiment of the invention.

FIG. 17 illustrates podports and podways with three routes submitted at similar times in an embodiment of the invention.

FIG. 18 illustrates management of passenger commute in an embodiment of the invention.

FIG. 19 illustrates management of parcels from a warehouse to a home in an embodiment of the invention.

FIG. 20 illustrates management of passengers or parcels in an embodiment of the invention.

FIG. 21 illustrates dronepods or carpods merging on podways in an embodiment of the invention.

FIG. 22 illustrates an example of ETA timing when merging in an embodiment of the invention.

FIG. 23 is a comprehensive view of an overall proposed local transport system according to an embodiment of the invention.

### DETAILED DESCRIPTION OF THE INVENTION

### Terminology

The following provides terminology used in this application:
pod=An enclosed compartment that can accommodate two or more passengers or parcels or other goods. The pod has a door and a large re-chargeable battery and is attachable at its top or base to a transport vehicle.
transport vehicle=An intelligent drone or intelligent chassis with controllable motors, attachable to a pod.
drone=An intelligent drone that can autonomously fly or attach to or detach from the top of a pod.
dronepod=An intelligent drone that when attached to the top of a pod can autonomously fly it.
carpod=An intelligent chassis that can autonomously drive or attach to or detach from the base of a pod.
carpod (external to a podport)=trampod, or railpod, or tunnelpod, or carpod (on legacy road).
carpod (inside a podport)=An intelligent chassis with an attached pod driving on a podport transfer path.
trampod=one carpod driving on a tramway.
railpod=one carpod driving on an overhead rail.
podport (PP)=An exchange station where pods can be detached from or attached to transport vehicles in entry bays or exit bays and linked by transfer paths with the transit bay or parcel bay or parking bays.
dronepod stop, trampod stop, railpod stop=podstop where passengers or parcels can enter or exit a pod without the transport vehicle detaching.
podcharger (PC)=pole with horizontal slider or wireless transmitter that charges the battery of a dronepod or railpod or trampod or carpod while it traverses along the charger.
transport system control (TSC)=overall control system for all pod-based journeys via podports and podchargers, and also any pod in an emergency situation. TSC creates and deletes a Cluster Network Control number (CNC[#] for each pod's journey through the system.
cluster network control number CNC[#] supervises a pod's journey traveling through the system from origin to destination. It is disabled by TSC at journey completion, and its information may be subsequently stored.
route=journey from defined origin to destination via any of podports, podchargers, and podstops.
hop=all the podways linked between two podports.
podway=droneway or [carpod] with start and end at a podport, podcharger, podstop, or marker.
marker=physical structure at the start and end of a podway, uniquely detectable by a traversing carpod, and if a beacon contacts an overhead dronepod. May have the ability to contact a podport.
droneway=beacon to beacon straight line for a dronepod at a specified height above ground.
[carpod]way=tramway or railpodway or carpodway.
endway=end of a podway.

### Carpods, Trampods, Railpods

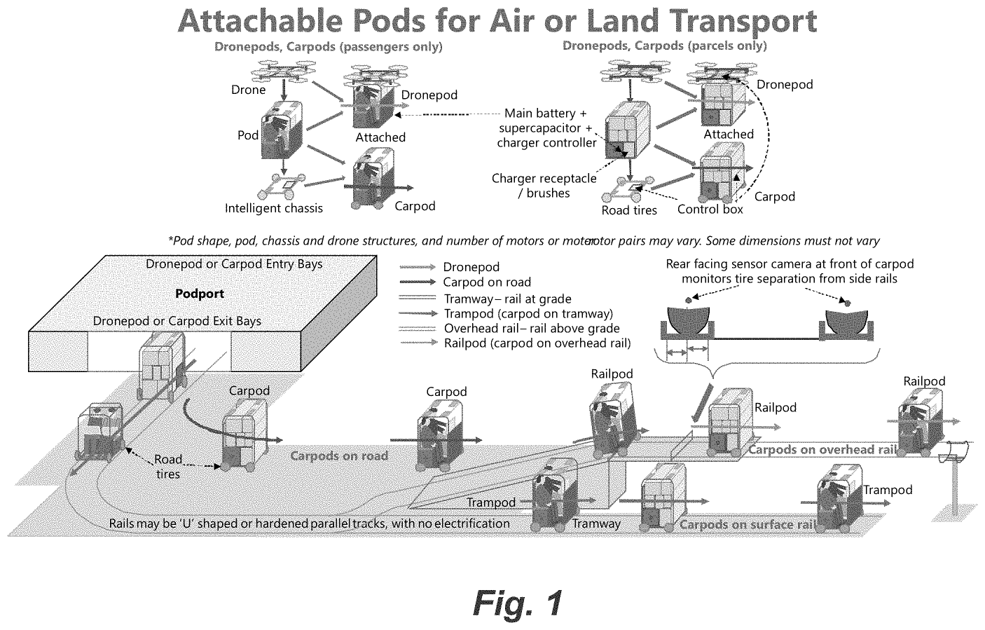

Referring to FIG. 1, carpods, when outside the podport may be used as trampods or railpods or even tunnel pods, as well as carpods. This is because they are all the same vehicle—a pod mounted on and attached to an intelligent chassis with battery that has road friendly tires. Trampods are merely carpods on a tramway, where the tramway comprises two parallel rails each of which may just be a square ‘U’ shaped groove on a hardened surface as shown. Railpods are merely carpods on overhead rail, where the rails may be two parallel square ‘U’ shaped rails, probably made of hard composite material of light weight, with supports at regular intervals. Initially for 1-railpod traffic, these supports can be spaced further apart, but as traffic increases and 4-railpods or higher numbers of linked carpods become necessary, additional supports may be inserted along the tracks. Tunnelpods are merely carpods on an underground tramway, where the tramway is defined above. Carpods will eventually be able to self-drive autonomously on present day roads with legacy traffic of limited intelligence. All these various carpod configurations enter or exit a podport as carpods on tracks or just a solid surface.

Carpods can exit a podport at surface level to become a trampod on rails or ascend a ramp to become a railpod on an overhead rail, or descend into a tunnel, in each case the rails need no power lines. Or in the future when Level 4+ or 5 car technology is certified, just remain as a carpod on a normal road amongst legacy traffic. The transition from carpod to trampod to railpod to tunnelpod is performed outside podports, with all configurations using the intelligent chassis as the transport vehicle. The important fact here is that the overhead rail uses the same carpod—the wheels and frame supporting the pod, instead of hanging from a trolley suspended below the rails. This has a major advantage in that the podport need only internally support carpods and dronepods, greatly simplifying the podport design while allowing the podport to be very versatile.

### Electronic Coupling of Multi-Pod Vehicles

The multiple pod vehicles shown in FIG. 1, may have pods linked to each other electronically as they exit the podport, i.e., not linked mechanically. Because the drones and the chassis already have forward and rearward looking sensors for normal travel to avoid obstacles and other traffic while traveling autonomously, these same sensors can be used to maintain a short gap from the pod in front to the pod behind in a train of pods. This saves the need for a mechanical coupler, which is advantageous for reducing the weight of the overhead railpod, as well as reducing wear and tear of the mechanical links. It also enables a shorter turning radius of the 4-pod vehicle. The smaller turning radius allows the turns upon entering or exiting the podport to also be smaller, resulting in a more compact podport. [Carpods] could be configured such that if one [carpod] fails due say to low battery power, the chassis in the one behind could be activated to push it to a safe location.

### Chassis Tires in Center of ‘U’ Shaped Rail

To save on tire wear both inside and outside the podport, rearward facing sensors at the front of the chassis monitor the gap between the front tire sidewalls and the rail sidewalls. They provide a feedback system that ensures the tires stay in the middle of the rails and not touch the sidewalls of the transfer path inside the podport which may comprise a square ‘U’ shaped cut into a solid surface. The same sensors will be used outside the podport on tramways and overhead rail for monitoring the distance from the sidewalls. This helps guide the [carpod] through the turns on the overhead rail or tramway.

### Wireless Signals and Power Links Between Pod and Transport Vehicle

To maintain an elevated level of redundancy in the [carpod] or dronepod to maximize safety, an additional wireless link for sensor and control signals using say the latest WiFi version between pod and transport vehicle will greatly increase reliability, complementing the wired link plus connector. And it is likely a secondary power connection between pod and transport vehicle will eventually be wireless because wireless power capability is improving fast. This will allow for multiple redundancy, enhancing safety, both inside and outside the podport.

### Pods Remain Airtight Throughout the Journey

Because the pod remains closed for the whole journey, including traversing through all the podports along the way, the isolated enclosed pod minimizes infection risk for passengers, offers privacy for the whole journey, minimizes contamination for sensitive content, and more easily maintains temperature and pressure. This offers major advantages over most forms of local transport where the travel compartment is shared along the way, and the door is opened and closed.

### Transfer Through Podports

### Carpods on Transfer Paths in Podports

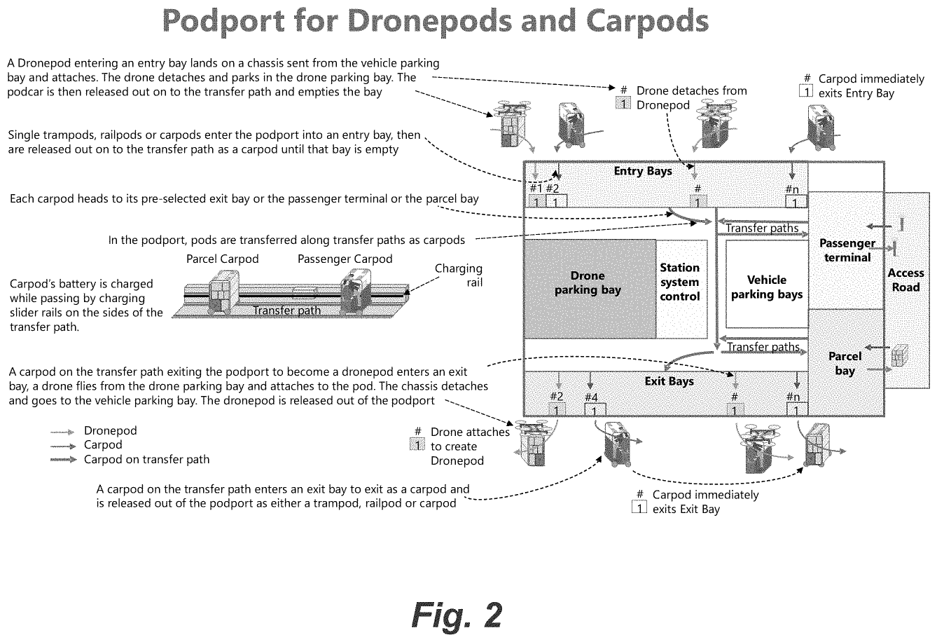

Passengers or parcels in a pod, when traveling through the podport, stay in the same pod from podport entry to exit, see FIG. 2. They travel in carpods on the transfer paths that can be square ‘U’ shaped cuts on a solid surface. These podport-based carpods can be identical to carpods as defined while outside the podport. Using identical carpods for both inside and outside the podport provides ease of interfacing at the entry and exit bays of the podport.

### Entry and Exit Bays

The podports allow interchanges between the two forms of transport vehicle: 1-chassis and 1-drones. The layout can be greatly simplified by combining all of these into a number of entry bays of a single type or exit bays of a single type, all managed by software in the Station System Control unit of the podport. If the podport is initially built for say 4-pods, even though initial usage might be for 1-pods only, then as the traffic inside the podport increases, and 4-pod vehicles become necessary, there will be no need to re-layout the bays for 4-pods. Merely by installing additional software in the Station System Control, the system can determine which size of train, one or four, and whether dronepod or carpod.

Each arriving dronepod or carpod is directed to enter a pre-selected available entry bay in the podport. If a carpod enters an entry bay, it is simply released on to the internal transfer path as a carpod.

But instead, if a dronepod enters an entry bay, it lands on top of a waiting 1-chassis just transferred from the chassis parking bay, creating a carpod with the drone still on top. The drone then detaches from the carpod, resulting in a short delay, and flies to the drone parking bay to recharge and await its next call. In both cases the remaining carpod is released and serially travels down the transfer path as a carpod. After leaving an entry bay or passenger terminal or parcel bay in the podport, the carpod travels along the internal transfer path, where the pod is automatically recharged. The carpod transfers to its pre-selected exit bay, or passenger terminal or parcel bay. If a carpod is pre-selected to exit the podport from a certain exit bay, the carpod exits the transfer path to the pre-selected exit bay and can be immediately released by station system control to exit the podport. For exiting dronepods, an unattached fully charged drone from the drone parking bay attaches to the top of the carpod just arrived in the pre-selected exit bay. Then the chassis beneath is detached, creating a dronepod, causing a similar slight delay. The chassis transfers to the chassis parking bay to be recharged while the dronepod is released by station system control and exits the podport.

### Advantage of Sharing Dronepods and Carpods in the Same Exit and Entry Bays

Allowing for both dronepod/s or carpod/s to enter any available entry bay overcomes queuing issues caused by surges of dronepods only or carpods only, when arriving. Similarly, when exiting, the exit bays can support both carpods and dronepods.

This therefore does not confine how the exit bays can be used. This is provided there are enough 1-chassis in the chassis parking bay when many dronepods are arriving, or enough 1-drones in the drone parking bay when exiting. Minimizing queuing will result in average less delays at busy times. This layout of identical entry bays and identical exit bays that accommodate both dronepods and carpods results in a very versatile podport design and layout.

### Allowing any Number of Carpods in a Train

Because carpods can be linked together in a train, probably electronically, this allows creation of a number of carpods in a train. If two carpods are waiting to leave an exit bay and the podport system knows there is no sign of another going to the same podport, there is no point waiting, and the two can be linked electronically and exit together. Conversely if more than four are going to the same podport and all are ready to exit, once the pre-selected exit bay is full, a second exit bay can take a train of overflow carpods 5-8 and they can link up with the train from 1-4 during exiting. Or if more than four carpods are coupled together in a train that is arriving at a podport, the second train 5-8 will be sent to another entry bay. Any of these will result in average lower delays. 4-railpods and 4-trampods can be charged on podchargers as with 1-railpods and 1-trampods, although the power required from the podcharger will be four times higher.

### Urgent Passengers or Priority Goods

There will be often a need for passengers to require an urgent journey, which may for example be requested by owners of privately owned pods, to travel at maximum speed through the system. There may be a similar urgent need for say medical kits or certain goods to be sent through the system at high speed. It is likely these cases will accept paying additional fees for high-speed service. One approach to achieve fast thruput is by using only 1-pods the whole journey so that upon arriving at a podport, the closest available entry bay can be assigned to the carpod or dronepod. The 1-carpod or 1-dronepod will immediately enter this entry bay, and if it is a dronepod, it attaches to the waiting intelligent chassis, and its drone will detach. The carpod exits the entry bay, down the transfer path to the nearest pre-assigned available exit bay and exit as a 1-carpod or 1-dronepod. The Cluster Network Controller for this user, CNC[#], will have also selected the fastest hops between podports with a priority over other users entering the same podways so will enter podways immediately.

### Charging Pods on the Transfer Path

The podport transfer path can be configured to have two parallel charging slider rails, positive and negative, to be fitted to one side of the transfer path. This allows the pods to charge while traversing the transfer path as shown in FIG. 2, alleviating the need for a charger in the exit bay to do the charging, thereby speeding up the time a pod traverses through the podport. The pod's battery could be fully charged along the transfer path such that no delay is needed in the exit bay due to charging. To ensure this, taking the worst case, if a podport's system control has determined that the incoming carpod's battery is just about fully discharged upon arrival at an entry bay, this carpod could be sent to the furthest distance available exit bay to give the carpod enough time to become fully charged along the transfer path. Or the carpod could be slowed down to ensure its battery is fully charged by the time it has reached the end of its transfer path.

This is important because it allows transport system control (TSC) and the assigned cluster network controller CNC[#] to assume that any carpod or dronepod departing a podport is fully charged, and can be guaranteed to travel a certain distance, and therefore can calculate whether it can or cannot reach the next podport or podcharger, or the final destination and return the empty pod back to a podport. Once charging is complete the amount of charge is checked with the amount specified for that pod that TSC has that information. It is possible that batteries may be of different capacities making this relevant information, requiring that TSC must know the battery capacity of each pod. And that it can select a pod with enough capacity for the maximum distance of the pod's planned route. Also, the pod's battery can be checked at the start of charging to ensure the amount of charge remaining after the last hop is what was expected. This checks that the battery is functioning correctly.

### Transfer Path Markers

As the carpod travels along a transfer path in the podport it uses electronic markers positioned at exit paths as direction indicators to guide the carpod: if the pod while passing a marker does not recognize the exit id, it stays on the main transfer path. If it does recognize the marker for its exit location, it turns into that path which is an exit path to its destination inside the podport. The marker could beam a message id indicating the carpod to exit, or it could be just a pole with the exit marker written on it which a camera in the pod detects the exit marker by matching the wording with its pre-programmed wording for that exit.

### Charging Passing Carpods or Dronepods at a Podport Without Changing Transport Vehicles

It is possible on a long hop between two pre-selected podports that a pod's battery may not have sufficient battery charge to complete the hop. Besides the use of podchargers, there are two ways a pod can be charged using an interim podport along the route. The pod could pass directly into and through this interim podport and get charged while traversing its internal transfer path. Another approach is to install podchargers at relevant podports so if the dronepod or carpod will have an insufficient charge on a hop between two podports, it can be directed to a waiting podcharger at an intermediate podport where it will fully charge while traversing by. This obviously requires installing podchargers at interim podports where some podports are too far apart. Installation should not be a major issue because the land was already acquired for the podport and permission to add the podcharger may be a formality.

### Layout of Podport and its Vicinity

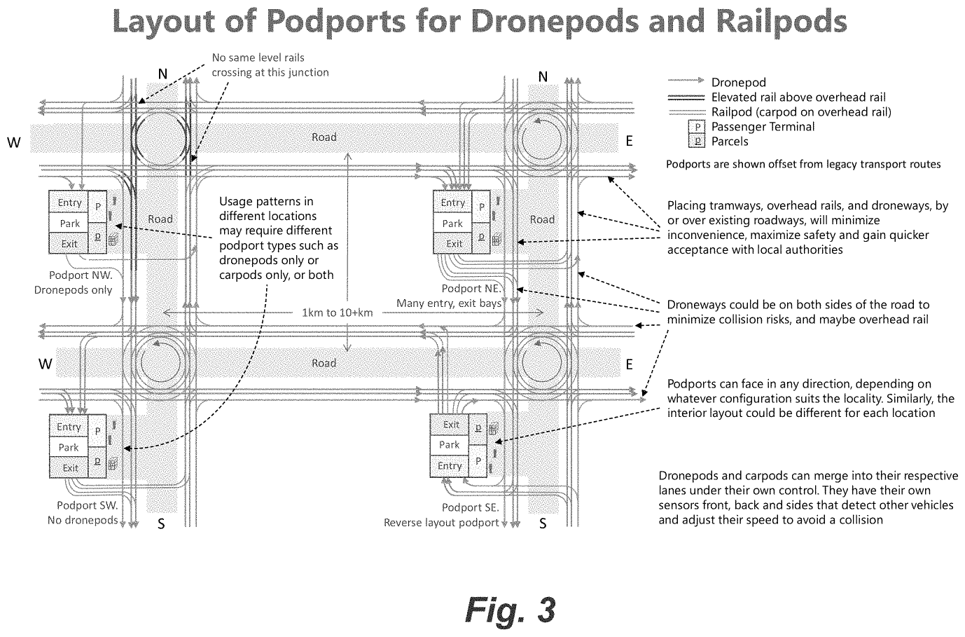

The layout and placement of podports is also important as shown in FIG. 3. To make it easier for the local population to accept these new forms of transport in a built-up area, droneways, tramways, and overhead rail will not necessarily take the shortest distance as the crow flies. Instead, they are more likely to be located on either side or center of existing roads.

The optimum positioning for the entry and exit bays of the podport is at opposite ends of the podport, with the passenger terminal and parcel bay on one of the sides. Probably the best location of a podport is offset relative to say a crossroads. This offset podport supports travel of dronepods on both sides of the road as shown, minimizing risk of collision. The layout also facilitates easy merging of carpods and dronepods to or from a podport with the main throughways.

The layout shown allows the podport to be easily built and upgraded. It also enables fast throughput of pods in the podport. Podports can be laid out in any direction, such as interchanging north and south, etc., and podports can be built initially as just dronepod only, or carpod only, or both, as shown. Parcel and passenger entry and exit can be direct from the access road.

### Podport 1-Floor Layout

The design and layout of podports is crucial to the success of the autonomous attached pod methodology, by offering low construction cost, small area, easy access, fast throughput, and mixing of parcels and passengers.

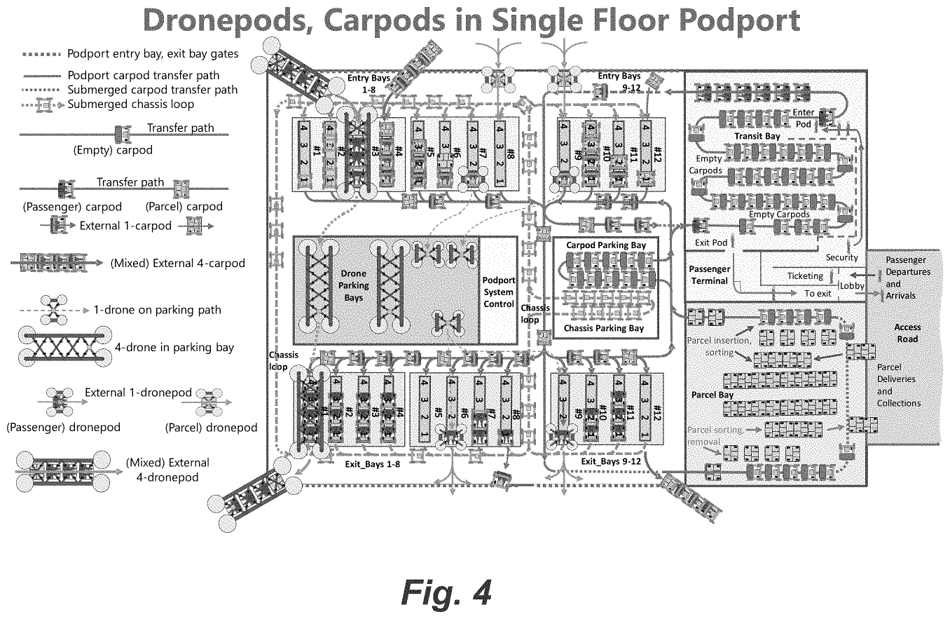

FIG. 4 shows a single floor podport example supporting one and four dronepods and one and four carpods. Twelve identical entry bays and twelve identical exit bays are shown as examples, as well as a passenger terminal and its transit bay for loading and unloading passengers, and a parcel bay. Both are connected to the access road for passenger arrivals and departures, and parcel delivery and collection. Inside the podport, upon exiting the entry bay or transit bay or parcel bay, carpods with passengers or parcels pass down the transfer path to an exit bay, or carpods from the entry bays pass down the transfer path to the transit bay or parcel bay for unloading. Excess empty carpods can be stored first in the transit bay, and if any overflow, into the carpod parking bay.

When a dronepod arrives at a pre-selected entry bay at a specific time, a fully charged chassis or four chassis will have already driven from the chassis parking bay along the chassis transfer loop to the entry bay. The dronepod lands on and attaches to the chassis, the drone then detaches from the pod/s and flies to the drone parking bay where it recharges. It lands on pillars that at the top have an identical set of connectors as the top of a pod, so that the drone's battery can be charged while parked on the pillars. Conversely when a dronepod is to exit the podport, a charged drone flies to the carpod/s in the exit bay and lands on top, attaching to the pod/s. The chassis then drives off along the chassis transfer loop, which may be submerged, to the chassis parking bay where it is recharged. The submerged chassis path is thus a loop, with chassis driving to the chassis parking bay from an exit bay for dronepods exiting the podport, and chassis driving from the chassis parking bay to an entry bay when a dronepod enters the podport. If the loop is submerged, then carpods traveling along transfer paths are not delayed if a carpod intersects a chassis passing on the loop.

There is also a need to minimize the number of carpod turns along the podport's transfer path, both to maximize speed through the podport along the transfer path because turns slow down the carpod, and to minimize passenger inconvenience while turning on a tight turn. A tighter turn will also minimize the additional layout area of each turn keeping the podport base area small. To minimize the number of turns in a podport, some transfer path links can be submerged while passing under a transfer path.

### Podport 2-Floor Layout

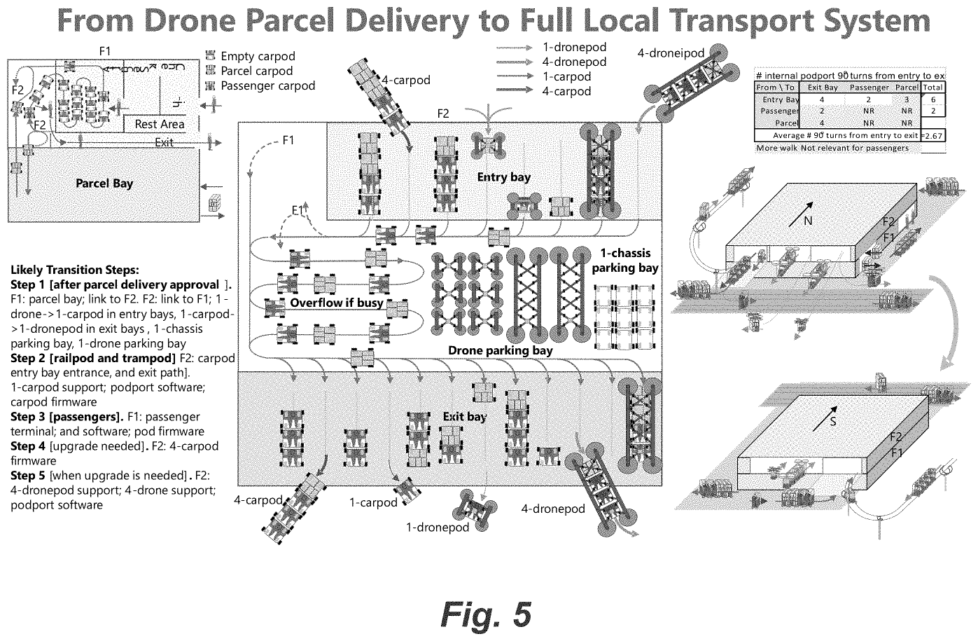

Podports can be designed for a single floor or multiple floors. FIG. 5 shows a two-floor example of how just a parcel warehouse can be upgraded in small steps to become a podport that supports both types and size of transport vehicle, as well as full passenger transport. Parcels and passengers enter and exit on floor 1, and dronepods and carpods on floor 2, above local traffic. If the podport supports overhead rail, then the overhead rail can enter and exit above grade direct to floor 2. It is also beneficial for dronepods to enter and exit the podport above ground level to avoid obstacles below at ground level. This proposed stepped upgrade approach allows minimal disruption of the podport during upgrades, by continually upgrading hardware and software in incremental steps on the two floors, in conjunction with upgrading firmware in the pods and transport vehicles, and podport software.
Step 1. Parcel delivery by 1-dronepod is likely to be implemented ahead of pod-based tramways/overhead rail, once approval for general BVLOS drone parcel delivery has been granted by the FAA, and by other countries' flight authorities. This will enable dronepod delivery for medical kits, parcels, urgent mail, meals and food, or factory parts, etc. to homes or hospitals or factories or other buildings, possibly in that order.
Podport Tasks to Upgrade from Just a Parcel Warehouse: [F=floor number]. Build F2 above F1.

F1: start with the existing parcel bay or if new construction, add a parcel bay; add a link transfer path up to F2. Add entry and exit transfer paths for parcel carpods to the up and down links to and from F2.

F2: add a link transfer path down to F1; add 1-dronepod→1-carpod in entry bays and 1-carpoid→1-dronepod in exit bays with control software (SW); add 1-drone parking bay and transfer link to entry and exit bays including control SW, which may also include hardware (HW) for possible 4-dronepod support to allow for easier future upgrading; add 1-chassis transfer loop to entry and exit bays, and associated control SW; then as demand requires add 1-chassis parking bay.
Parcel Pod, 1-drone, 1-chassis Tasks: add pods; 1-drones and 1-chassis including sensor and motor control and battery system HW and firmware (FW).
External Tasks: Add TSC ticketing and vetting SW, emergency SW, diagnostics SW. CNC: add management SW, podport communications SW. Build podports, dronepod stops, podchargers, podway markers.
Step 2. Adds parcel transport capability for trampods, railpods adjacent to or above legacy roads (and later L4, L5 compatible carpods on legacy roads). Also relies on interested parties committing to building infrastructure. This is a trivial task inside the podport but a big one outside.
Internal Tasks: F2: entry and exit bay SW; carpod FW. External Tasks: Outside the podport, a lot more work is needed to build overhead rail for 1-railpods and/or tramways for 1-trampods.
Step 3. Add capability for passenger railpods, trampods, and passenger drones once international and country standards have been developed. For a parcel delivery company this allows the passenger dronepod, trampod and railpod application to be leased out.
Podport Tasks: F1: Add passenger terminal (check-in, security check, rest area) and transit bay; add SW for podport passenger control.
Pod Tasks: add pod FW for passenger monitoring, emergencies, communication, and entertainment.
External Tasks: TSC: add SW for passenger monitoring, emergencies, communication, and entertainment.
F2: no changes.
Step 4. Add parcel delivery and passenger transport by 4-carpod. This is a trivial step compared to the others. It can be re prioritized if parcel business grows fast and 4-carpods become necessary sooner.
Podport Tasks: F1: no change. F2: 4-carpod support in entry and exit bays. HW not needed if 1-carpods can be linked electronically; add entry and exit bay control SW. Parcel Pod, 1-drone, 1-chassis Tasks: add 4-carpod FW for a carpod to be the leading carpod in a train.
Step 5. Add parcel delivery and passenger transport by 4-dronepod. This is likely to be launched after trams/overhead rail depending on 1-dronepod usage once approval for parcel delivery by 4-dronepod has been granted. This step can be re prioritized if parcel or passenger business grows fast and 4-dronepods become necessary sooner.
Podport Tasks: F1: no change. F2: 4-dronepod support in entry and exit bays; 4-drone parking. HW for both may have been built in Step 1; add entry and exit bay control SW.
Parcel Pod, 1-drone, 1-chassis Tasks: add 4-drone and FW for a dronepod to be the leading dronepod in a train.

### Parcel Transport Through Podports

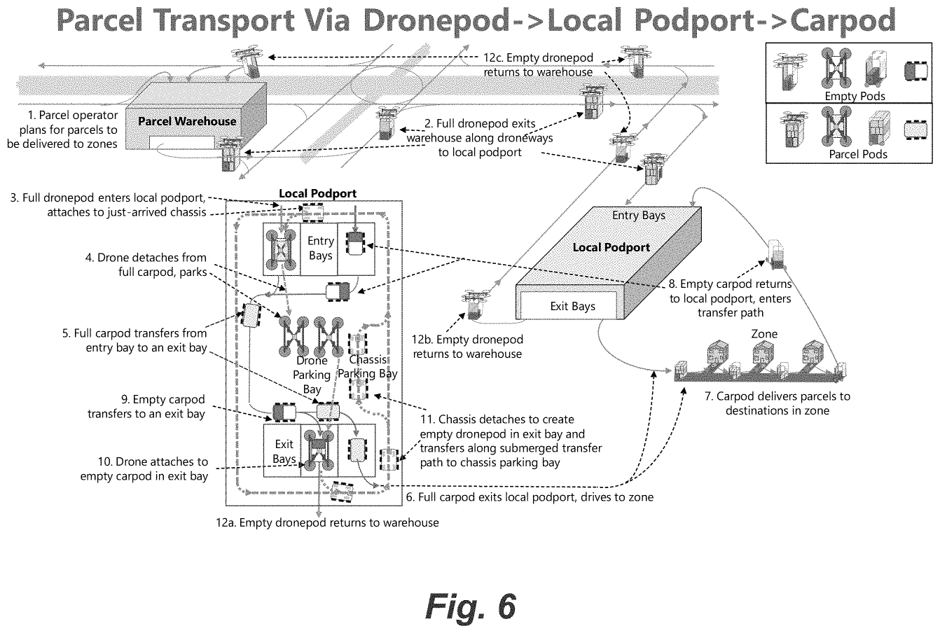

Fully autonomous transport of parcels could initially evolve from either drone parcel delivery, or small parcel carrying robots on a sidewalk or local road, or a combination of drones and carpods that are in fact street robots. FIG. 6 shows such a combination: a parcel-based drone transport system that can use an existing parcel delivery warehouse that has been upgraded to support dronepods. The podports collect and deliver parcels either in a dronepod or via the access road.

A dronepod comprises the transport vehicle carrying a pod with parcels. The dronepod traverses along publicly approved droneways to a pre-selected local podport. In a simple example like in FIG. 6, the local podport can accept dronepods and carpods. The carpods in this example autonomously drive along sidewalks or designated sections of road such as a bike lane to a local zone of targeted homes.

The parcels remain in the same pod that they were loaded into in the parcel warehouse, through the local podport to the delivery zone, and the pod remains closed and locked throughout the journey. In the Fig., inside the local podport at the pre-selected entry bay, the dronepod lands on a waiting chassis that has driven itself from the chassis parking bay to the entry bay. The dronepod attaches to the chassis underneath and the drone detaches from the top of the pod and flies to the drone parking bay. The pod latched to the chassis is now configured as a carpod, which travels down the transfer path to an exit bay where it can immediately exit the local podport and drive itself autonomously to the delivery zone.

At the delivery zone it offloads the parcels in turn at the preselected homes, by automatically opening the pod's door, and dropping the parcel/s off using for example the pod's mechanical arm, on to the home's marked loading pad. The arm retracts, the pod door closes, and the dronepod autonomously drives to the next pre-selected home and the sequence repeats, until at the last pre-selected home the now empty carpod autonomously drives back to the local podport.

It enters the local podport at the pre-selected entry bay and travels down the transfer path to an exit bay, where a drone from the drone parking bay flies on to the top of the carpod and attaches to it. The chassis underneath then detaches and autonomously drives to the chassis parking bay. The dronepod in the exit bay now exits the local podport and autonomously flies back to the parcel warehouse, where it waits for its next load of parcels.

FIG. 6 is an example of a dronepod link between the parcel warehouse and the local podport, and a carpod or street robot link between the local podport and delivery zone. This could instead be a carpod (or trampod or overhead rail) link between the parcel warehouse and the local podport and a dronepod link between the local podport and the delivery zone. The identical podport would work for either.

Fully autonomous transport of parcels could initially evolve from either drone parcel delivery, or small parcel carrying robots on a sidewalk or local road.

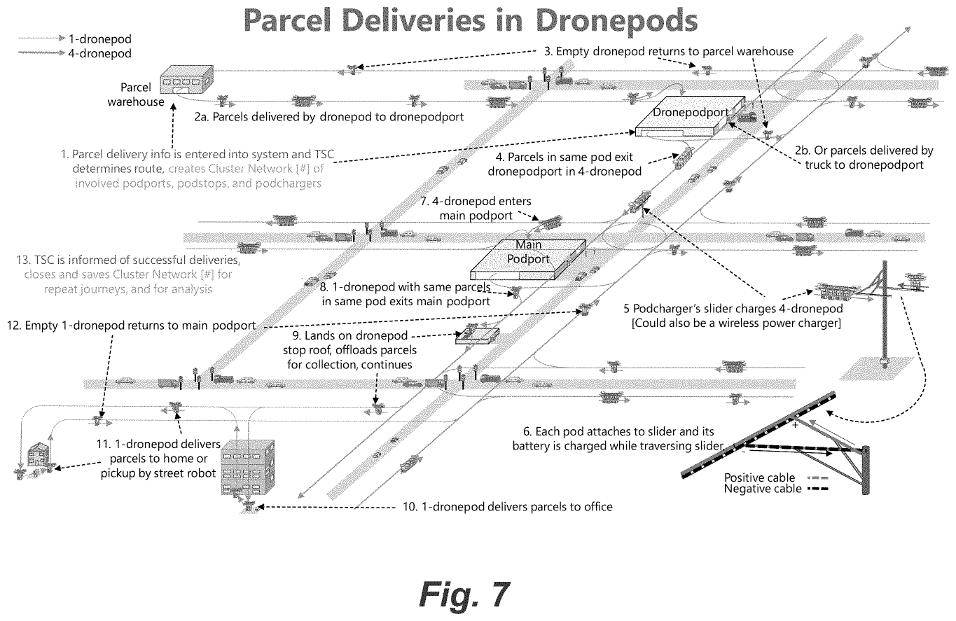

FIG. 7 shows a parcel-based drone transport system that can use an existing parcel delivery warehouse that has been upgraded to support 1-dronepods and later 4-dronepods. The podports collect and deliver parcels either in a dronepod or via the access road. The parcels remain in the same pod until eventually at the last podport, they either enter the parcel bay for pickup, or enter an exit bay where a 1-dronepod then autonomously flies the parcel/s to a customer, or a group of customers in the vicinity. Each such delivery is direct to the customer's prescribed delivery zone which may be to a designated marked landing area or by a front door or to a balcony, etc.

Or it can be to a rendezvous with a small parcel carrying robot operating on a sidewalk, or a collection point like the dronepod stop shown in the Fig.. The dronepod routes could include strategically placed off-road 1-dronepod stops with the 1-dronepods landing on a landing zone which could be the stop's roof. This would allow parcels to be autonomously inserted or removed from a landed dronepod, for possible autonomous delivery or pickup by robots or people. No exchanging of transport vehicles occurs at these stops.

The pods with their transport vehicles can have unlimited range because they are charged either when in a podport or passing by a podcharger. While setting up the journey, transport system control (TSC) may have determined that a pod will not have adequate battery storage capacity to complete a segment of its journey, and therefore needs to re-charge while passing by a pre-selected podcharger. In the dronepod only example shown, the podcharger, referred to in USPTO U.S. Pat. No. 9,937,808, comprises a pole with two horizontal slider rails. After mechanical engagement with the pod, the pod's battery as the pod's brushes or receptacle pass along the slider rails. The speed at which the dronepod traverses the slider will depend on the charger and pod battery system capabilities, but as technology progresses this speed could increase to cruise speed such that the dronepod need not slow down. This interim charge gives the dronepod enough range to reach the final destination, which may be either the next podport as shown, or if just charged at the final podport of the journey, deliver the parcels to the external destination and then return the empty dronepod back to the final podport.

### Trampods and Railpods

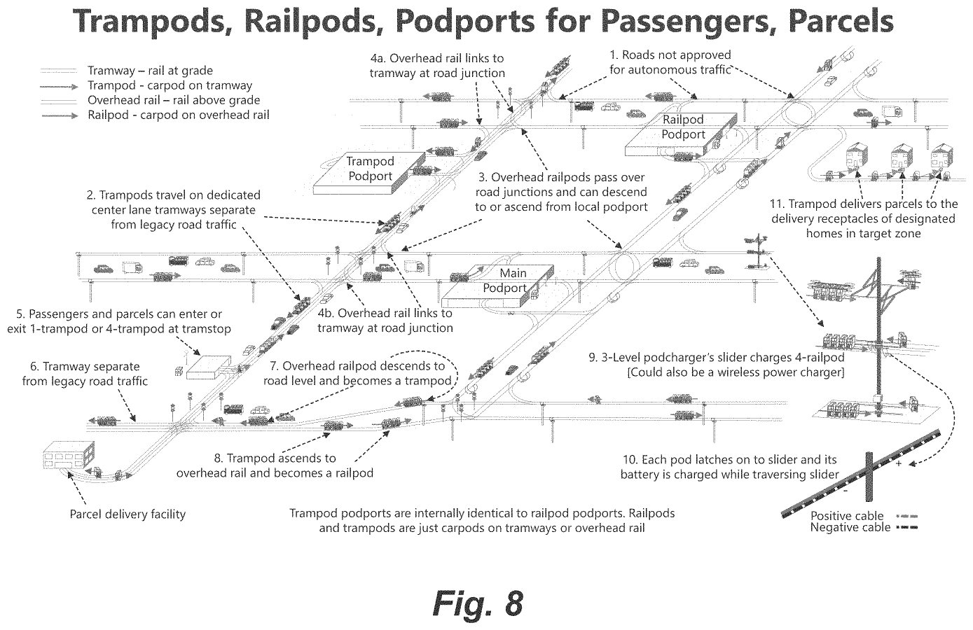

FIG. 8 includes an upgrade step to the transport system that adds trampods and railpods. The podport's entry and exit bays already support 1-carpods, so external infrastructure for trampods or railpods needs to be added. Carpods with road tires exiting the podport become trampods if exiting at grade level, or railpods if exiting on overhead rail above grade. The overhead rail system can be lower cost and easier to build than present day overhead rail because the railpods are much lighter, vehicle spacing is monitored so localized railpod crowding will not occur, no heavy metal rails are needed, and no heavy high voltage electric cables are needed (therefore also much safer).

Because trampods enter and exit at grade, external tramways are the simplest and lowest cost transport choice. Tramways are advantageous in areas where there are few junctions. Busy junctions can be bridged, using an overhead exceptionally light rail, because the pod with its intelligent chassis is lightweight. The bridge could be then extended later to continue the overhead rail. The extension could be built above existing roads for ease of installation and minimal discomfort to people living below on either side of an existing road or in the central reservation. Local authorities will obviously need to agree to these two forms of transport.

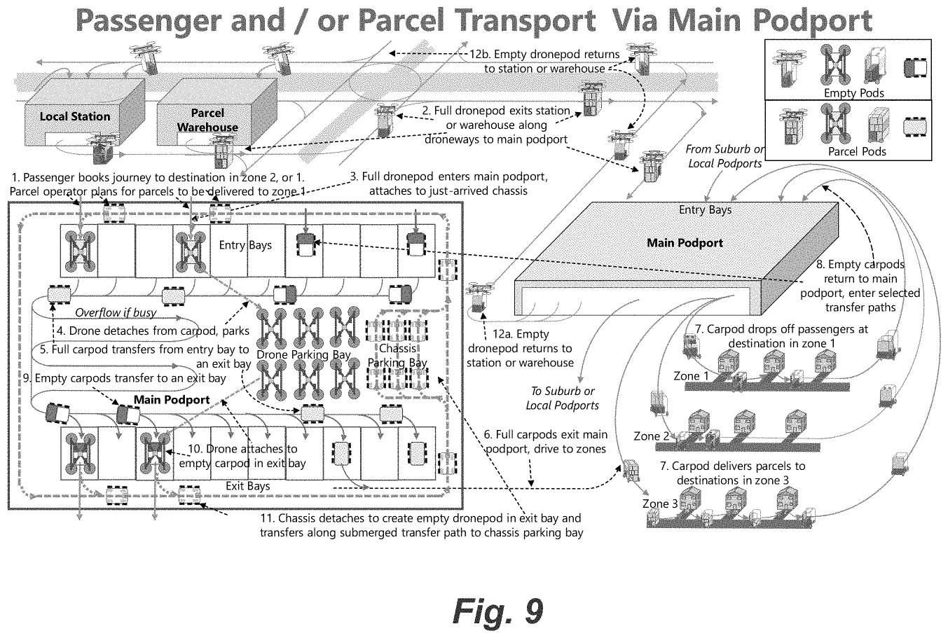

By keeping trampods at grade or railpods on overhead rail separate from legacy road traffic, or pedestrians or bikes from crossing their path uncontrolled, the trampods and railpods will operate on controlled no interruption routes, except when trampods come to a road junction. These autonomous trampods and railpods have sensors and controls in both the pod and chassis that support detection of other traffic or unexpected obstacles in front or sides, and to enable safe merging at junctions. Links between the tramway and overhead rail at busy junctions are shown in FIG. 9. Fully autonomous travel on legacy roads is not ready yet so is not presently considered an option, but when it is, these same carpods can be used, albeit operating with significantly improved software.

### Mixed Load Transport

Pods can include passengers as well as parcels, and the use of either is independent of transport vehicle and podports. There may be a difference in the pod for each, as long as the weight restrictions and key dimensions are the same. The entire system can manage both passengers and parcels, with simultaneous and seamless transport of both. Podports will need to add a passenger terminal comprising check-in, security, transit bay, rest area etc. as shown in FIGS. 4 and 5.

Only Transport System Control and Cluster Network Control will know the difference and arrange for the relevant pod type to be called to pick up and deliver the passengers or parcels, then will inform the first and last podport in a journey to activate either the passenger terminal and transit bay, or the parcel bay.

Manufacturers of passenger drones are in the process of trying to get them certified. Future podports will support passengers for carpods, so the additional support needed for passenger dronepods is minimal, because the passenger terminal with its transit bay will already support trampods and railpods, and the entry and exit bays already support dronepods.

The transport system operator may allow privately owned or company owned pods, or specialty pods, for passengers, parcels, or light goods, but these must comply to a future pod standard.

FIG. 8 shows how a basic combination of passenger and parcel transport may interoperate with a local station for passengers, and a parcel warehouse for parcels, both connected by dronepods to a main podport, and then by carpod to some local zones to deliver the parcels or passengers or pick up passengers. The podport comprises entry bays that can accept both dronepods from the parcel warehouse or passenger station as well as carpods returning from the zones. The carpods could be on a private tramway or dedicated pathway on the road.

A simple, low-cost example of a parcel/passenger local transport system can comprise a parcel warehouse, a station, and a podport. This configuration can support parcel only, or passenger only, or a combination.

FIG. 9 shows an example of a group of parcels that are ready to be sent to a targeted zone. A dronepod in the parcel warehouse is loaded with the parcels, the full dronepod then exits the parcel warehouse and approaches an entry bay of the main podport. Or similarly if a passenger is ready to be picked up at the station, the dronepod picks up the passenger, exits the station, flies to the main podport, and approaches an entry bay. A chassis from the chassis parking bay first drives autonomously to the bay, then waits till the dronepod lands on it and attaches to it. The drone detaches and then flies to the drone parking bay to be charged, leaving an occupied carpod.

The carpod then autonomously drives along the internal transfer path to an exit bay. During the transfer, the carpod is charged as it traverses the transfer path, such that at arrival at the exit bay it is already fully charged. In the exit bay it drives out to one of the zones to either deliver parcels to some homes in the zone, or takes the passenger/s to a home, or picks up a passenger or parcels. The carpod then autonomously returns to the main podport along a specified route to a pre-selected entry bay.

The carpod drives into the entry bay, and if clear, proceeds along the transfer path where the pod is charged, to a pre-selected exit bay, and waits for a drone from the drone parking bay to land on it, then attach to it. Then the chassis detaches and drives to the chassis parking bay. The drone flies to either the local station to drop off the passenger or pick up another passenger going via the main podport to a zone, or pick up more parcels at the parcel warehouse, or just park and wait for another command.

This configuration is for drones to operate between the warehouse or station and the main podport, and carpods between the main podport and the zones. Another alternative would be instead of carpods to have smaller less range drones between the podport and zones. This would require these drones to be approved for BVLOS (beyond visual line of sight) for both parcels and passengers, which could require the drones to fly above roads instead of people and property. Note that in all examples, the passenger/s and parcels stay in the same pod for the whole journey, minimizing chances of infection, or deterioration of the parcel contents.

### Transport System Control and Cluster Network Control

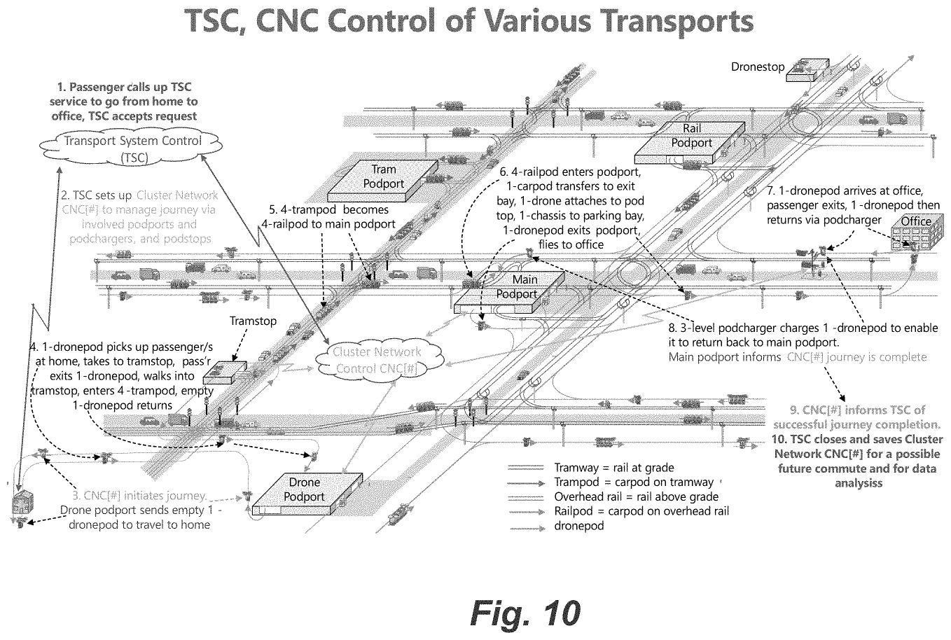

FIG. 10 shows a full featured local transport system, with 1-,4-trampods/railpods and 1-,4-dronepods, carrying passengers or parcels, all interoperating seamlessly together. Both dronepods and trampods/railpods can be used to offer fully autonomous passenger transport or parcel delivery routes with segments of the journey utilizing one or the other type of transport vehicle. The example shown is for a typical passenger commute. But the podports will also accept and deliver parcels in a dronepod, railpod, or trampod, as shown. Other podports shown support dronepod-only or carpod-only transport, depending on the local transport needs. Also shown are a tramstop and a dronestop, where only passengers or parcels can enter or exit the stop, but with no capability to exchange transport vehicles.

Each pod's journey from origin to destination is set up initially by transport system control (TSC). Once the passenger or the parcel operator has agreed to the proposed route, TSC sets up a temporary cluster network controller CNC[#] that routes the journey in hops via pre-selected podports, podchargers, and podstops on the agreed-to route. CNC[#] manages the pod's journey through these podports, podchargers, and podstops, messaging with each upon arriving and departing, thereby freeing up TSC to perform its many other tasks. Once the pod has reached its destination, the destination podport alerts CNC[#], which informs TSC. TSC then shuts down that cluster network CNC[#], saving the information for possible repeat use or for data analytics.

In the commute example shown in FIG. 10, the final segment for the pod is too long for the storage capability of the pod's battery so the battery must be charged to enable the dronepod to reach the main podport. The cluster network controller CNC[#], designated to control this journey, was aware of this when initiating the journey and determined that the dronepod must be charged at the 3-level podcharger on the return segment. This podcharger comprises three heights of charging sliders for each of dronepod, railpod and trampod. The podcharger charges the dronepod sufficiently more than is needed for the dronepod to be able to reach the main podport. Alternately, instead of a hardwired slider, a wireless power charger can be used if it can supply the power required and the pod supports wireless charging.

So overall high-level control is managed by TSC, and the individual journeys are managed by temporary CNCs, which are individually disabled by TSC whenever that CNC's journey that it manages is completed.

### Transport System Hardware Links

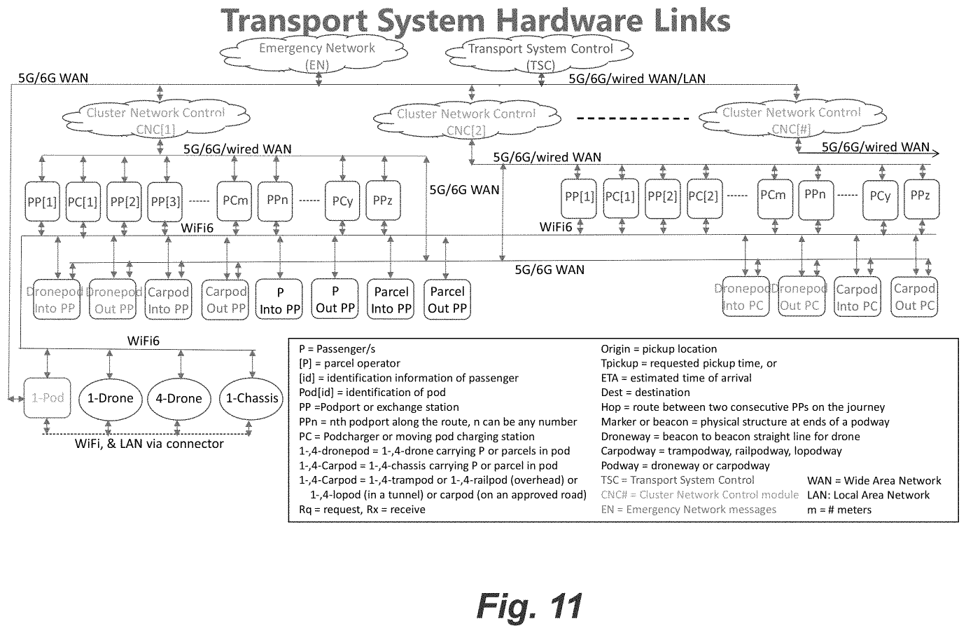

FIG. 11 shows the connections of the various hardware blocks in the complete system. TSC will link initially by 5G then in the future by 6G, or a wired WAN, or if in the same building, probably a LAN, to the cluster network control modules (CNCs) it sets up for all the active journeys. At the completion of a journey, it de-activates the controlling CNC[#] and stores the journey's information in a data base for data analysis and repeat journeys or hops of a journey. Each CNC[#] that TSC sets up manages the assigned pod and all the podports, podchargers and podstops that the pod interacts with during the journey. Each CNC[#] will link by 5G or in the future 6G or even wired WAN, to the PP's and PC's it selected, as well as selected stops (not shown in the Fig.) i.e., dronepod stops, trampod stops, railpod stops, and later carpod stops, along the journey.

TSC also directly connects to any pod that has an emergency situation, which could be a passenger problem, a parcel problem such as overheating, or a dislodgement. Or the pod or transport vehicle may be experiencing a mechanical problem. Or there may be a problem with an upcoming podport or podcharger. In any of these cases a system operator will need to talk directly with the pod's passenger or the parcel operator.

External communication for each podport, PP, is through the podport's station system control unit using 5G/6G. The PPs communicate at an elevated level with the CNC[#] that assigned the journey's planned podports, and with the charging PCs passed by during the hop to the next podport. The PPs must also communicate with their assigned dronepods and carpods when in the vicinity, and in particular next and previous podport, stops, and podway markers if necessary. PP's will also sometimes have to link via 5G/6G direct to a pod when it is external to the podport, typically at the first and/or last podports, when initially picking up and/or later dropping off the passenger or parcels. The PP may use WiFi or a 5G variant whenever an external dronepod or carpod is within range.

The PP also communicates internally using WiFi, for station system control to its passenger terminal, transit bay, parcel bay, entry bays and exit bays, dronepods and carpods entering and exiting, and carpods on its transfer path including monitoring each pod's charge as it traverses the transfer path while charging.

PCs will link via 5G/6G to approaching dronepods, railpods and trampods and then when in range of WiFi, switch over to WiFi to engage and later disengage the slider. After departing the PC, communication (if needed) will be by 5G/6G.

There also will be a 5G/6G link between the pod's control box for the passenger/s and TSC and the emergency network so that urgent interrupts can get immediate access for high level control issues.

Pods and transport vehicles when attaching or detaching in podports will communicate both through a wired LAN when attached, and WiFi before, during, and after attachment or detachment.

### Transport System Software Including Firmware

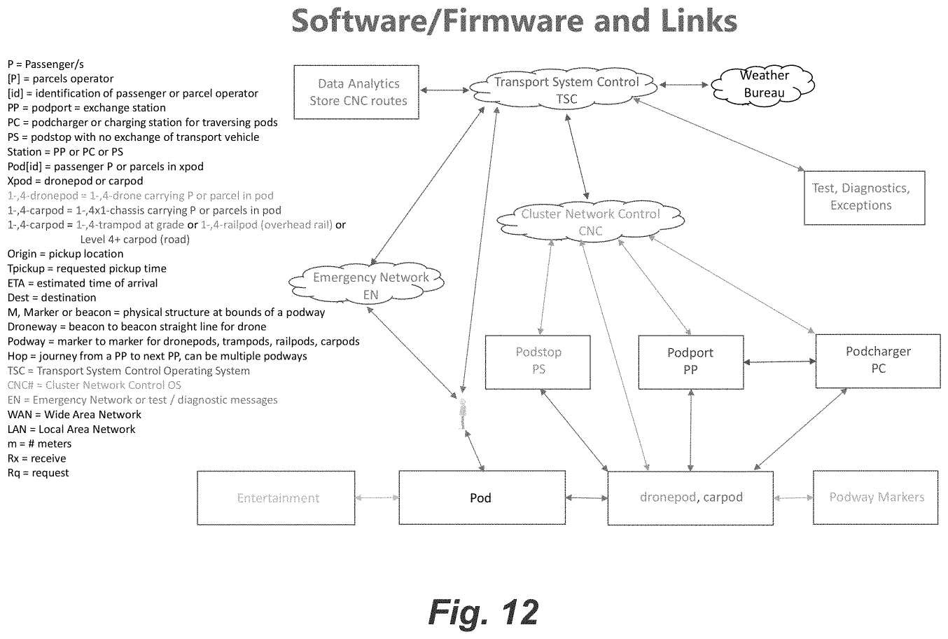

FIG. 12 shows the software and firmware links for the entire system. TSC sets up each CNC[#] when required and closes it down at the end of that pod's journey. TSC also communicates with the local weather bureau during set up of a journey, the emergency network on a high priority as needed basis, and for tests, diagnostics, and exceptions. The CNC[#]'s communicate with their selected PP's, PC's, and PS's (shown in FIGS. 8, 10, including dronepod stops, trampod stops, and railpod stops). These communications occur upon setting up a new CNC[#], and then between CNC[#] and the podport as the pod approaches and then departs each PP, PC, or stop along the journey.

Each pod's control box communicates externally to its attached transport vehicle and entertainment module, and internally with the passenger/s and internal controls (not shown).

Dronepods and carpods communicate while in or near a podport, podcharger, and podstop, via their pods. During a journey they also communicate with podway markers along the pre-selected route to ensure they are on course. They may if required communicate while passing each marker on the hop.

### Transport System Control

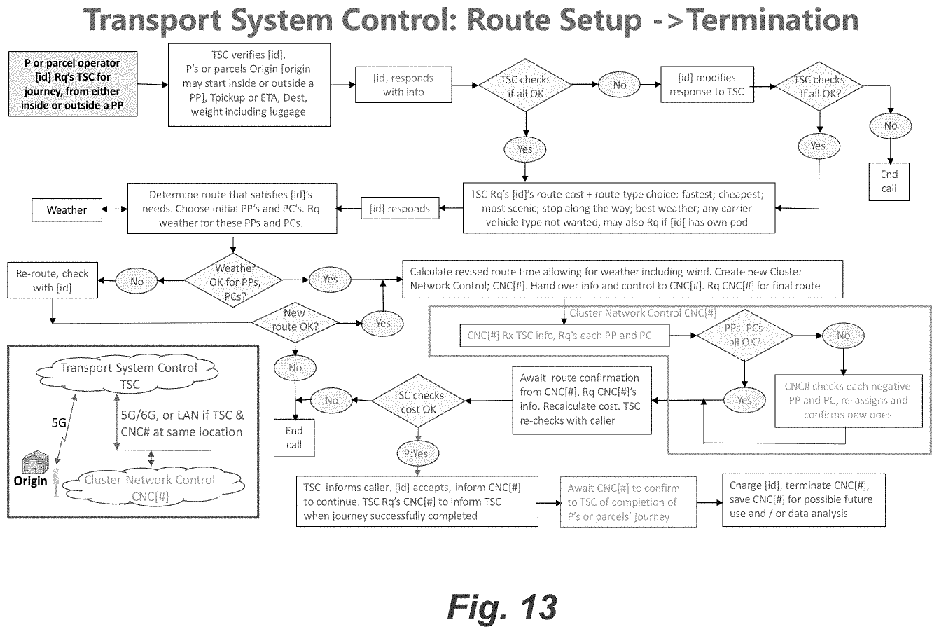

FIG. 13 shows in more detail the flow of TSC operation, which is mainly with the passenger or parcel operator setting up the journey, including with CNC[#] setting up and managing the journey.

Initially the passenger [P] or parcel operator [O], designated [id], contacts TSC either by a mobile device or at a kiosk to request a journey from Origin to Destination, where both Origin and Destination could either be inside a PP or in the vicinity of one. TSC then authenticates [id], determines pickup time or planned ETA, and selects the best PPs for Origin and Destination. It then needs to know the approximate payload weight, which if it is a passenger includes luggage, another passenger, or children. It checks the weather and any possible delays along the way, then calculates the approximate route. It then requests [id] to select the best route to take, depending on [id]'s travel priorities. These could be: fastest (dronepod, then railpod, then trampod), cheapest (trampod), most scenic (dronepod, railpod), most comfortable, safest, or any carrier vehicle type not wanted, and if relevant will [id] use its own pod? [id] responds, TSC determines the journey more accurately after checking the weather along the route. If the weather is not acceptable in a particular part of the journey, TSC recalculates a better route and checks with [id]. If not acceptable to [id], TSC aborts and informs [id].

If the proposed route is acceptable to [id], TSC re-calculates journey time including wind effects, and creates a new Cluster of PPs, PCs, and stops, that will enable completion of the journey. TSC then hands over control of the journey by creating a Cluster Network Controller CNC[#] to manage the pod's journey. CNC[#] then accesses and verifies with each PP and PC, calculates the ETA of the pod at each PP and PC, and informs the PP or PC. If there are any issues, CNC[#] re-assigns problematic PPs or PCs to others in the vicinity. CNC[#] then informs TSC, which recalculates the cost, and If not OK with [id], TSC terminates the session. If OK, TSC informs CNC[#] that it can commence the journey, and then inform TSC when successfully completed. There is no further need for TSC to communicate any more for the duration of the trip. At the termination of the trip, CNC[#] informs TSC. TSC then shuts down CNC[#] and probably stores the journey's details in a database for future data analytics and/or for future repeats of all or part of the journey.

### Cluster Network Control

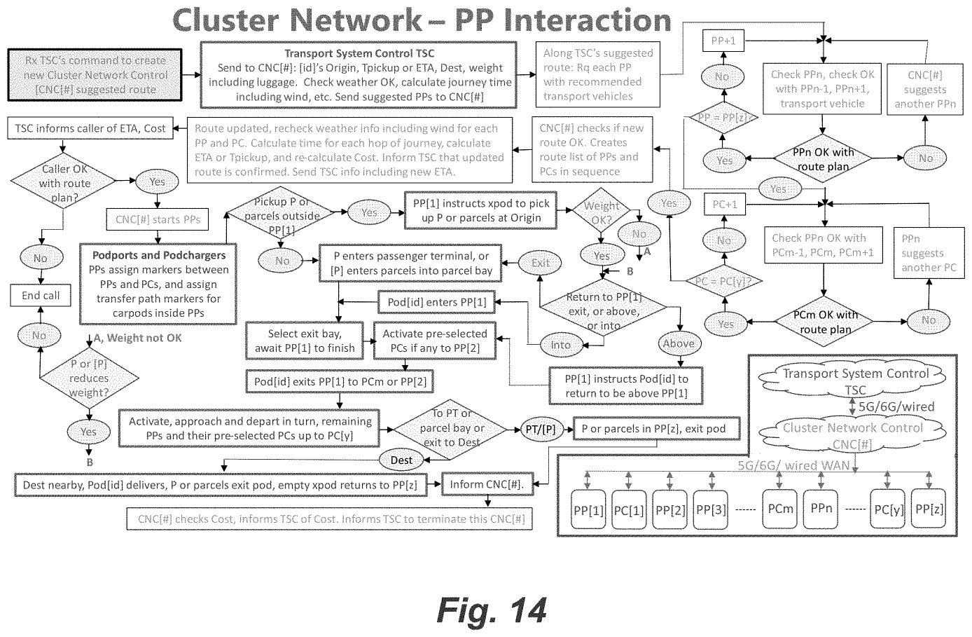

Each Cluster Network Control CNC[#] supervises a pod's journey traveling through the system from origin to destination. It is initially set up by transport system control (TSC) and subsequently disabled by TSC when the pod has completed its journey, and the CNC[#] information subsequently stored. It mainly communicates with podports and podchargers that CNC[#] has selected for the journey, as shown in FIG. 14. Once set up by TSC, CNC[#] then instructs PP[1] to commence the journey starting at Origin, which may be internal to PP[1] or external within range of PP[1]. If external, PP[1] instructs an empty carpod parked in the empty carpod parking bay, to traverse the transfer path to the designated exit bay. If the pickup vehicle is a carpod, the carpod exits the exit bay and travels as a trampod along rails on the ground at grade or as a railpod on elevated rails above grade. If instead the pickup vehicle is a dronepod, a 1-drone flies from the drone parking bay to land on and attach to the carpod's roof, the 1-chassis is detached and the 1-dronepod exits the podport. In either case the trampod, or railpod, or dronepod travels to the Origin, which may be a home.

f a dronepod, it lands on a prescribed landing pad, or the trampod stops at a prescribed location. The pod door is opened, and the passenger/s step in or parcels are loaded in. If the weight of the payload is above the maximum allowed CNC[#] informs [id] the weight must be reduced. If not reduced within a certain period, the pod informs [id] that the journey is aborted. If the weight is initially or subsequently within limits, the pod and transport vehicle are designated Pod[id]. Then it informs PP[1] that the payload is ready. PP[1] then instructs Pod[id] to either return to be above PP[1] or enter PP[1] and traverse to a prescribed exit bay, or just enter PP[1] and traverse to the transit bay or the parcel bay for the passenger or parcels to subsequently exit PP[1]. Or the instruction could have been for the passenger/s to enter PP[1] at the passenger terminal or the parcels at the parcel bay, to be subsequently transferred on to the transfer path to an exit bay. Once Pod[id] has either exited PP[1] or is above PP[1], it then transfers to PP[2] possibly via PCs. Pod[id] then follows the prescribed list of PPs and PCs until it arrives at the last podport of the journey, PP[z]. If the passengers or parcels need to be delivered to Destination outside PP[z], Pod[id] departs PP[z] to deliver passenger/s or parcels to Destination, where they are picked up, and the empty Pod[id] returns to PP[z], enters it, and the chassis is parked in the chassis parking bay, or a drone is parked in the drone bay. PP[z] informs CNC[#] which then informs TSC that the journey is complete, and the CNC[#] data is then stored in an external database.

### Podports

Each podport's station system control unit can be fairly busy, depending on how many Pod[id]'s have been designated to pass through that podport. Each CNC[#] communicates with all the podports and podchargers along the agreed-to route. If there are several CNC[#]s active at any time, then some of them are likely to involve multiple inclusions of a same podport. Each podport therefore needs to maintain a dynamic list of which dronepods or trampods, or railpods, or carpods are approaching, in sequence. It then deletes the ones that have subsequently exited or terminated the journey in either its passenger terminal or parcel port. The podport's list will include arriving pods and their transport vehicles. This list can be updated at short notice, as passengers or parcels can be arriving from the access road at any time. An internal list for each podport is needed of pods presently inside the podport and their location relative to markers by the transfer path. This will include the state of charge of each carpod's pod along the transfer path, and carpods, drones and chassis parked in their parking bays. Then another list is created of the departing pods' transport vehicle, next podport, podway markers between this podport and the next, and podchargers between this podport and the next.

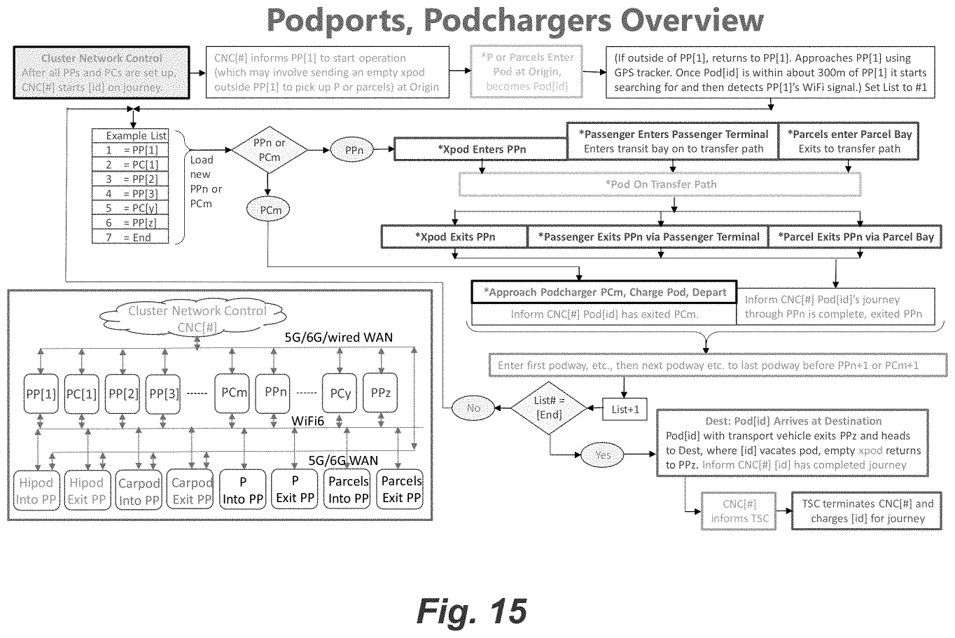

FIG. 15 shows how one arriving dronepod or carpod or arriving passenger/s or parcel/s from an entry bay or passenger terminal or parcel bay, travels through the podport on a transfer path as a carpod, to the passenger terminal or parcel bay or an exit bay.

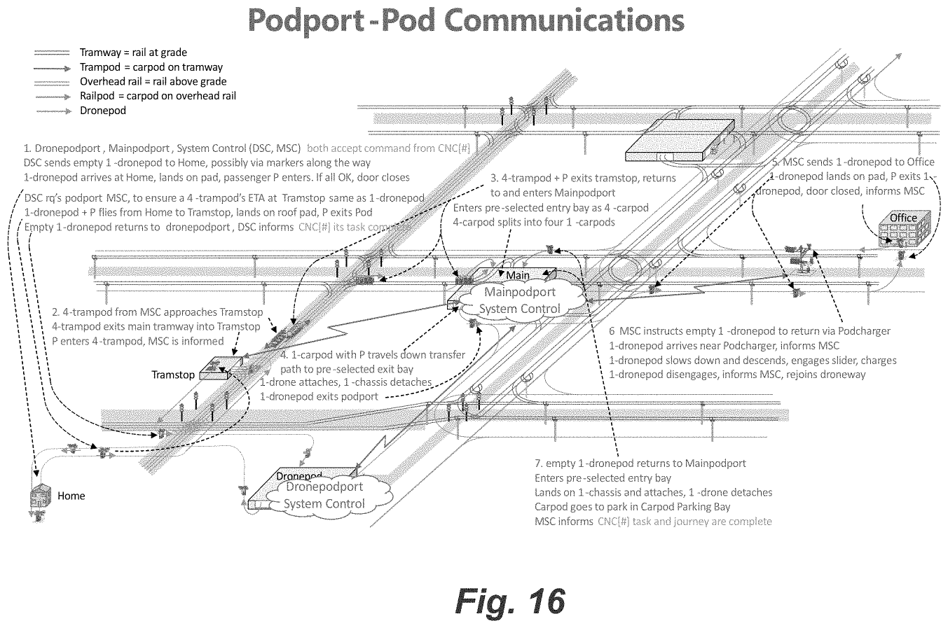

FIG. 16 shows an example of a commuter traveling from home via three forms of transport to the office. The commuter books the journey from home to office, and TSC/CNC[#] determines the best route. The commuter lives near the dronepodport, so TSC/CNC[#] arranges for a dronepod to pick up the commuter on a landing pad outside the home. The dronepod lands, its door automatically opens, the commuter enters, and if the weight is validated, the door closes. The dronepod flies to the roof of a local tramstop, where the commuter disembarks, CNC[#] is informed, and the empty drone returns to the dronepodport. The commuter enters the tramstop and awaits the next trampod to the mainpodport. The commuter enters an empty pod in the 4-trampod, which is confirmed to CNC[#].

The 4-trampod exits the tramstop and travels along the tramway to the next junction where it ascends and turns right on to an overhead rail that traverses past the mainpodport. Just before the podport an overhead rail branches off into the podport, which the 4-trampod takes, and enters the mainpodport as a 4-carpod. At the pre-selected entry bay, the 1-carpod with the commuter is released down the transfer path and at the same time the pod's battery is charged. The carpod enters the pre-selected exit bay. A drone flies from the parking bay and lands on the carpod, the chassis detaches and drives to the chassis parking bay. The fully charged dronepod then exits the podport and flies the commuter along droneways to the office and lands on a prescribed landing pad. The commuter exits the pod.

The dronepod then ascends to the pre-selected droneway. CNC[#] knew that the dronepod would not have sufficient charge to return direct to the mainpodport, so routes the dronepod along droneways to one that passes by a pre-selected podcharger, where it engages with it. The dronepod's pod is then fully charged as it traverses the slider, and then disengages from the podcharger. The dronepod then follows the pre-selected droneways back to the mainpodport where it enters to a pre-selected entry bay. A 1-chassis had already driven from the chassis parking bay to the entry bay, which the dronepod lands on and attaches to the chassis. The drone disengages and flies to the drone parking bay. The carpod drives to the carpod parking bay. CNC[#] is informed the journey is complete and informs TSC.

### Podway Definitions and Rules:

Route=journey between defined origin and destination via any of podports, podchargers, podstops, and marker/beacons.
Hop=all the podways linking two podports on a route, with no change of transport vehicle.
Podway=droneway, tramway, railpodway, or carpodway linked between any of podports, podchargers, podstops, markers or beacons, defined by a unique id, true heading setting between 0° and 360° to a PP, PC, and if a dronepod, altitude. Podways comprise droneways for dronepods or [carpodways] for trampods or railpods or carpods.
Marker=physical structure at start and end of a podway, uniquely detectable by a traversing pod. A marker or beacon may have the ability to contact a podport.
Droneway=beacon to beacon straight line for a dronepod at a specified height above ground. A dronepod in a droneway may change altitude close to any marker, or PC, or while by-passing a PP.
[Carpod]way=tramway or railpodway or carpodway. A carpod can morph between trampod, railpod, and carpod when very close to a marker, PC, or while by-passing a PP.
Xpod=dronepod, trampod, railpod, or carpod. Can join or exit a podway only at a PP, PC, PS, or a marker/beacon. An xpod can only change its type of transport vehicle at a PP, and not at a podway marker or PC or PS. An xpod informs CNC[#] when exiting a PP, PC, or PS and if pre-requested whenever passing a marker.
Endway=ending marker of a podway

### CNCs Set Up the Routes

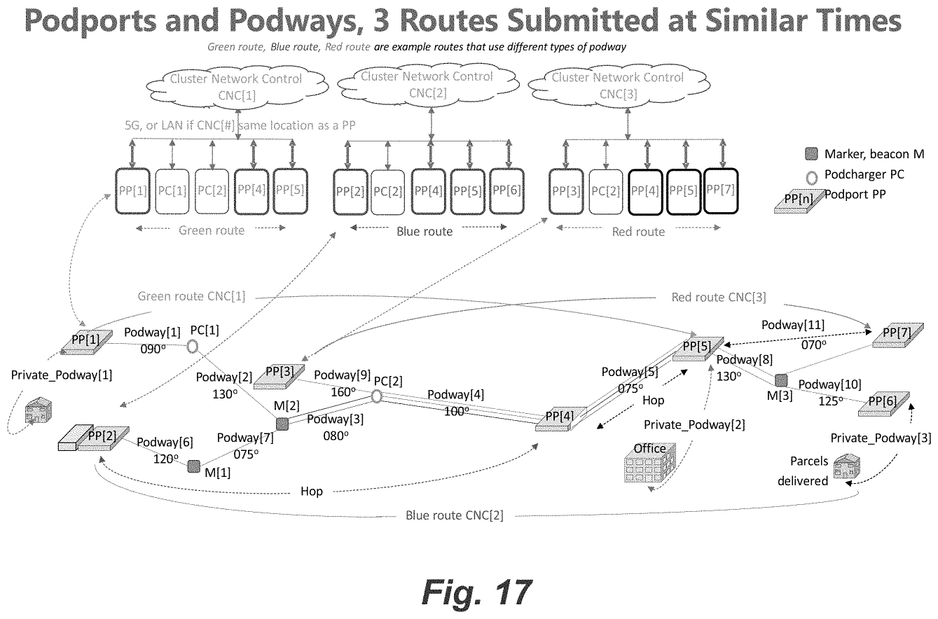

FIG. 17 shows the setting up of the dronepods, trampods, and railpods relative to their podways. During set up of CNC[#], TSC calculates the best droneways if a dronepod, or best combination of tramways, overhead rail, or road if a carpod. In this case ‘best’ means best for the type of journey requested by a passenger P or a parcel operator [PO], i.e., cheapest, or fastest, or best views, or safest, or most comfortable, or to avoid bad weather, or what type of transport vehicle is not acceptable etc. The Fig. shows three different routes, green, blue, and red, starting at PP[1], PP[2], PP[3] respectively. They are set up by 3 different CNC's, CNC[1], [2], [3], and share some of the same PPs and PCs at similar times. While setting up these routes, each podport creates a list of PCs, PSs, and markers for the hop to PPn+1. The list includes podway designations, the true heading of each podway, and estimated ETA for each xpod at each PC or marker. Upon preparing to leave PPn, the PPn downloads to the parting xpod this list for the hop to reach PPn+1. As each xpod approaches a PC, PS, or marker, it checks its list to monitor its position in the list. There is no need for CNC[#] to be involved between markers but it can be informed when an xpod is passing a marker.

Upon exiting a PP, if a dronepod, it then rotates determined by GPS heading and climbs vertically to a specified height above ground to the prescribed droneway, maintaining that height within a specified few feet. Droneways may be at different heights above ground level, depending on direction etc. If instead of a dronepod, a carpod will drive out of the PP, pass a marker, and join either a tramway or overhead rail or a tunnel.

Just before the xpod exits PPn, PPn informs CNC[#], which Acks OK (acknowledges receipt of info). The details transmitted include all the podways, PCs, and markers or beacons, their headings, and ETAs along the hop. The markers or beacons have unique identifiers so there can be no confusion of location, the pod knows exactly where it is. The xpod approaches a marker or beacon using its GPS, its camera, or ultra-wideband (UWB), to recognize the marker, and a radio signal probably using 5G also confirms in case of bad visibility, to determine it is the correct marker. Droneways, tramways, or overhead rail, change headings at each marker.

For droneways a few hundred feet above ground level, these markers could be beacons as with aircraft, such that a dronepod flying towards the beacon detects the beacon id expected and makes the relevant turn to the next droneway heading, following the GPS prescribed route, including adjusting for wind. Instead, on tramways, overhead rail, tunnels, and roadways, the markers can be a small pole with a unique id marker such that the chassis' sensors can detect the id either visually or by RFID or WiFi or UWB or some other means. The xpod then turns into the new heading on overhead rail or tram tracks and checks with its GPS the direction to the next marker.

The podway directions shown are in 5° steps but could be more accurate in use. The podway parameters are podway #, direction, start node, end node [endway], and height above ground for a dronepod. Also, for the traverse along a podway, the CNC[#] and ETA at the endway of a podway define the timing. TSC initially sets up the PPs to get from Origin to Destination. TSC checks the weather including wind and estimates which PCs to include. CNC[#] then requests the PPs involved to confirm PCs along the hop. Each PP then selects based on P's or the parcel operator's preference, the PCs, and marker-beacons (M) along the way and informs CNC[#], which will manage the Pod[id] along the hop.

Podport PPn has already been primed for arrival of Pod[id] by CNC[#] and has been provided with info on the next PPn+1. PPn knows the PCs between the two PPs. PPn will also know if Pod[id] has enough battery charge to reach PPn+1 safely, including charging at PCs, and taking into consideration local weather. PP[1] awaits CNC[#] to start Pod[id]. Each PPn+1 awaits PPn to signal Pod[id] has started the hop. The last PP knows to inform CNC[#] when Pod[id] has completed the journey. Each PP now has a list of the PCs and markers along the hop, the ETA for each, and the type of transport vehicle for that hop, whether 1-,4-dronepods or 1-,4-trampods, or 1-,4-railpods.

CNC[#] then instructs each PP on the route to set up every PC along the hops between PPs. All are made aware of the calculated ETAs of Pod[id] at all PCs or markers between the two PPs.

### CNC[1] Sets Up a Commute

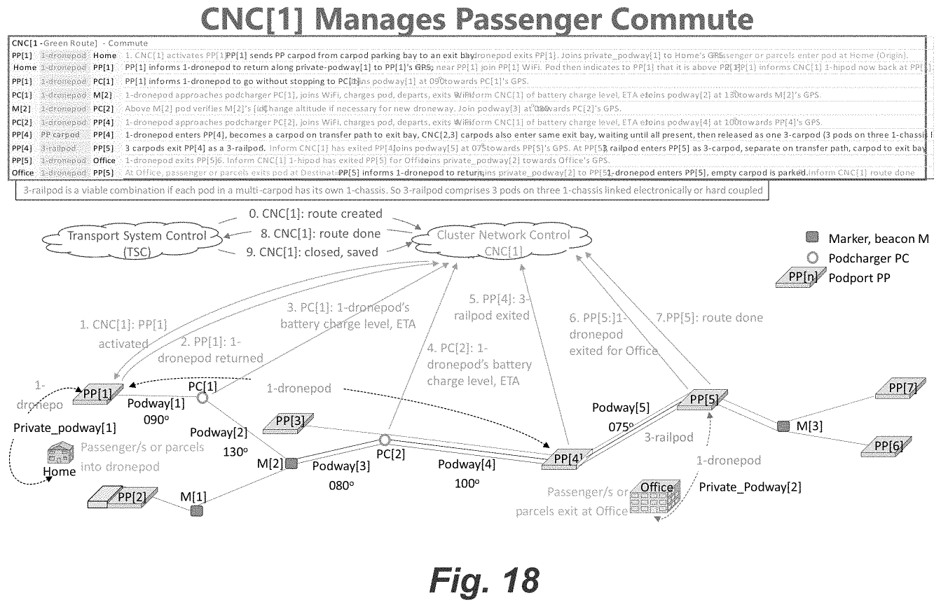

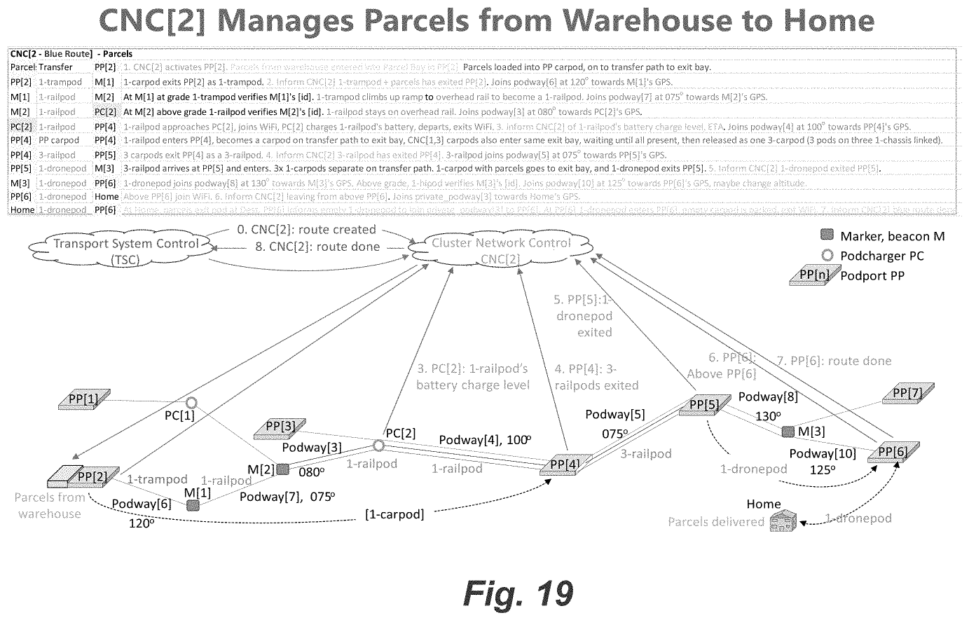

FIGS. 18, 19, 20 show the three different routes and the communications along each route. The passenger in FIG. 19 wishes to travel from home near PP[1] to an office near PP[5]. Once TSC has initially set up the journey, CNC[1] fine tunes it and determines the route that satisfies the passenger's needs. It then activates the journey, by transferring an empty fully charged 1-dronepod from PP[1], the nearest podport that has an available dronepod, to the passenger's home. It flies along Private_Podway[1] to a specified landing pad by the home. It descends to land, the door opens, the passenger/s enters, maybe with luggage, and provided the weight is less than the maximum allowed, the door closes. The dronepod ascends to the droneway Private_Podway[1] return height and returns to above PP[1]. PP[1] informs CNC[1] the dronepod has returned to PP[1]. Without stopping it rotates to 090° and heads along Podway[1] at the specified height. Within WiFi distance of PC[1], it then descends to PC[1] and recharges. The fully charged dronepod ascends to Podway[2] height and rotates to 130°. It informs CNC[1] it can now reach PC[2] via M[2] and Podway[3]. It descends to PC[2] and recharges again, informing CNC[1], then ascends to Podway[4], rotates to 100° to PP[4].

At PP[4] it enters an available entry bay and lands on a chassis that has already autonomously driven from the chassis parking bay. The drone detaches and flies to the drone parking bay. The remaining carpod exits the entry bay and travels down the transfer path, recharging while transferring. It arrives at an available exit bay where it exits to head along Podway[5] as a railpod to PP[5] on an overhead rail, informing CNC[1].

Upon arriving at PP[5] it enters an available entry bay and a drone from PP[5]'s drone parking bay attaches to the top. The chassis detaches and parks in the chassis parking bay and recharges. The dronepod exits PP[5], informing CNC[1], and heads along Private_Podway[2] to above the office where it descends on to a prescribed landing pad. The passenger exits and the dronepod returns to PP[5], the drone detaches and parks and recharges in the drone parking bay. The remaining carpod drives to the carpod parking bay where it recharges. PP[5] informs CNC[1] the journey is complete and CNC[1] informs TSC, which shuts it down and stores the CNC[1] info in a database for future use.

### CNC[2] Sets Up a Parcel Delivery

FIG. 19 shows an example of parcel delivery from a warehouse at PP[2] to someone's home near PP[6]. The parcel operator sets up the journey with TSC, which sets up CNC[2] to manage the route. Once set up, CNC[2] activates the journey, and the parcels in PP[2]'s parking bay are loaded into a waiting fully charged empty carpod which then travels to an available exit bay. It exits PP[2] as a trampod on to a tramway, Podway[6] at a heading 120°, and informs CNC[2]. It arrives at marker M[1] where it transfers up to overhead rail to become a railpod, along Podway[7] at 075°, to merge at M[2]. At M[2] the railpod joins Podway [3] and travels in the direction 080° to recharge at PC[2]. Upon leaving PC[2] fully charged, PC[2] informs CNC[2] and the railpod heads along Podway[4] at 100° to PP[4]. The railpod enters an available entry bay as a carpod, and immediately transfers while recharging to an available exit bay and exits as a railpod along Podway[5] to PP[5], informing CNC[2].

The railpod enters an entry bay in PP[5], transfers as a carpod and recharges along the transfer path to an available exit bay, where a fully charged drone flies from the drone parking bay and attaches to the top. It then lifts off and detaches from the chassis which drives to the chassis parking bay to be recharged. The dronepod exits PP[5] and PP[5] informs CNC[2]. The dronepod flies along Podway[8] at 125° to M[3] where it slightly redirects and may change height to Podway [8] at 130° to PP[6]. When the dronepod arrives above PP[6], it informs CNC[2] and flies along Private_Podway[3] to the office, where the dronepod lands on a landing pad. The parcels are removed, the parcel operator closes the pod door and the dronepod ascends to Private_Podway[3] again and returns to PP[6]. It enters the prescribed entry bay on to a waiting chassis and the drone detaches and flies to the drone parking bay to be recharged. The carpod parks in the carpod parking bay and recharges. PP[6] informs CNC[2] the journey is complete, and CNC[2] informs TSC, which shuts down CNC[2].

### CNC[3] Sets Up a Passenger or a Parcel Transfer

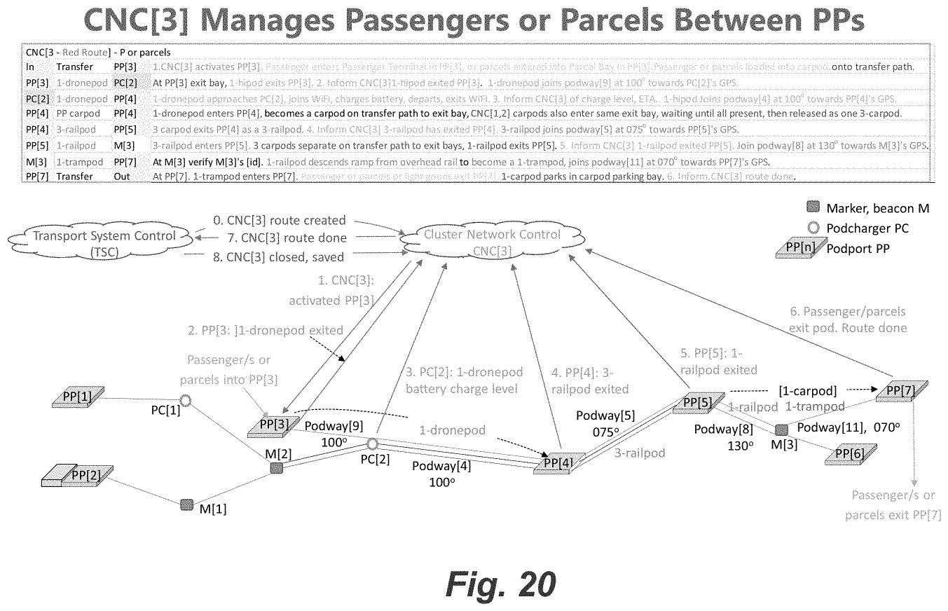

FIG. 20 shows an example of passengers or parcels entering podport PP[3] and exiting at PP[7]. The passenger/s enter the passenger terminal to check in, and once the route is accepted by TSC, the passenger/s enter the transit bay and enter a waiting carpod. Or in the case of parcels, the parcels are loaded into a waiting carpod in the parcel bay. TSC sets up CNC[3] with the passenger's or parcel operator's consent, and once set up CNC[3] activates the journey. The fully charged carpod transfers to the transfer path to an available exit bay. A fully charged drone from the drone parking bay lands on the top of the carpod and attaches to it, lifts off, and the chassis detaches and drives to the chassis parking bay to be charged. The dronepod exits PP[3] and ascends to Podway[9] height and rotates to 100°. While passing PC[2] it recharges. PC[2] informs CNC[3] that the dronepod is fully charged. It then ascends to Podway[4] along the same direction, to PP[4].

The dronepod enters PP[4], to an available entry bay that has a waiting fully charged chassis driven from the chassis parking bay. The dronepod attaches to the chassis and the drone detaches and flies to the drone parking bay to be recharged. The remaining carpod autonomously drives and recharges along the transfer path to the prescribed exit bay, where it informs CNC[3], exits PP[4], and ascends up to an overhead rail to PP[5]. Upon arrival at PP[5], the railpod enters as a carpod and transfers and charges along the transfer path to an available exit bay. The carpod exits PP[5] which informs CNC[3] and ascends to an overhead rail to M[3] along Podway[8] at 130°. Then it descends to Podway[11] at 070° on a tramway to PP[7]. It enters PP[7] as a carpod and enters either the transit bay if a passenger or the parcel bay. In either case the passenger or parcels are removed, the empty carpod drives to the carpod parking bay to be recharged, and PP[7] informs CNC[3]. CNC[3] informs TSC which deletes it, while saving the data of CNC[3].

### CNC[#]s Check for Possible Collisions While Merging

If the number of podports and pods proliferate, it will become increasingly likely that pod collisions could occur at merging podways. If two pods, both attached to the same type of transport vehicle on two different podways, merge on to a single podway, they will be candidates for a collision. A minimum distance between merging pods needs to be determined that allows one pod to be delayed or slowed down so as not to collide with the pod now in front. Too big a gap between the pods will cause more delays and slow down the entire system. The problem is how much to slow down or delay the pod behind.

There are two implementation methods that could be adopted to determine the delay. The easiest is to use sensors already in the pod and transport vehicle that control the transport vehicle drive motors to prevent collisions and maintain the pod on its prescribed course. The sensors must be able to determine the distance between the pods so that a calculation can be made for the amount to slow down. On-board camera sensors will need to be able to determine distance to the pod in front. Lidar sensors will give much better accuracy if installed.

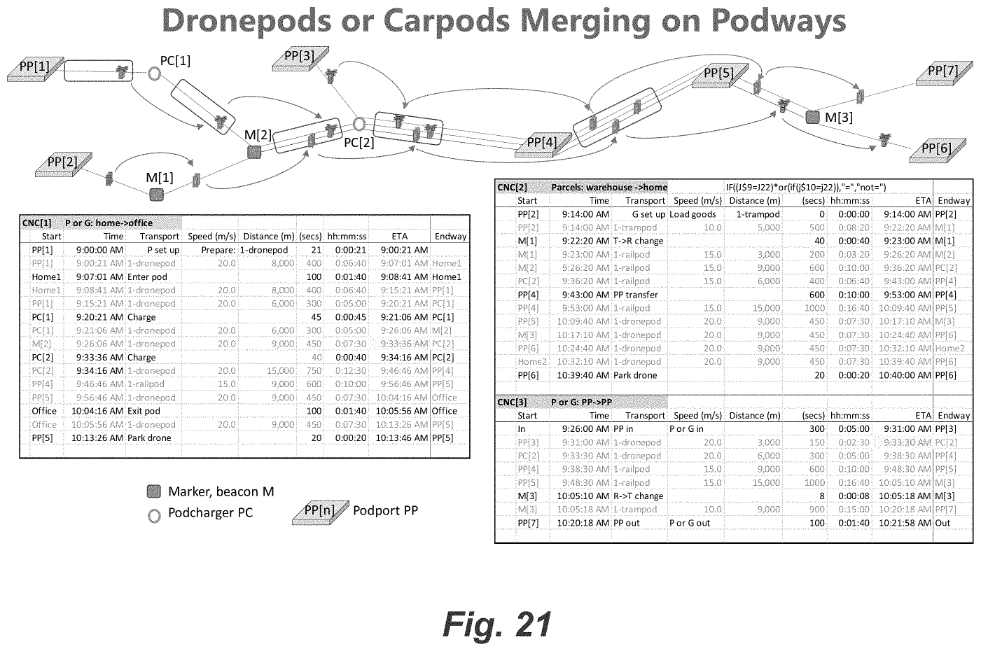

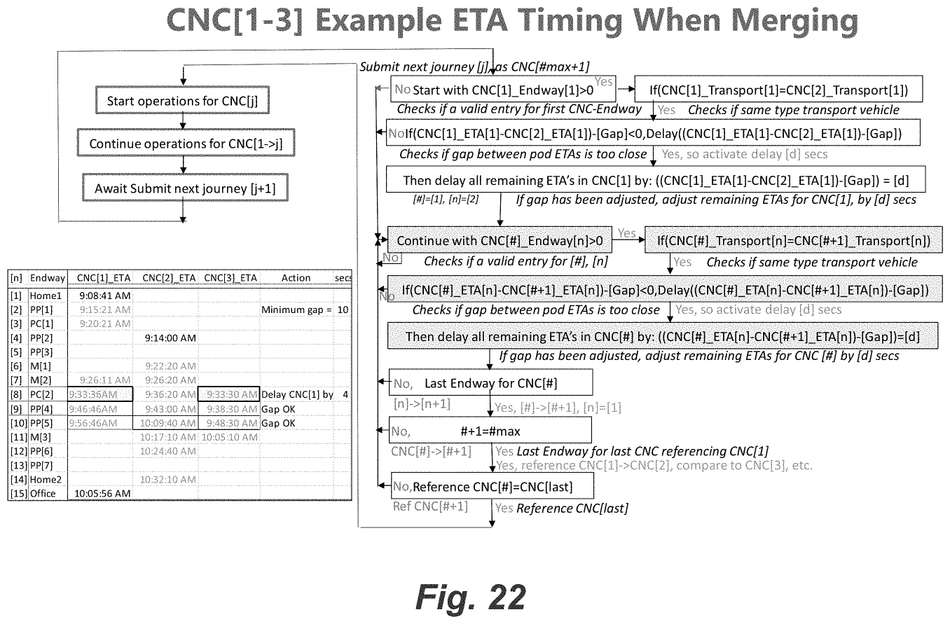

The second implementation uses the knowledge held by the CNC[#]s and PPs as shown in the tables in FIGS. 21 and 22, respectively. Each CNC[#] knows the ETA of the pod at each PP[#], PC[#] and M[#]. By checking all the CNC[#]s whenever a new CNC[#] is initiated, it is possible to determine if any ETAs of the different CNC[#]s are close enough to create a collision. The check at each node is only relevant for the same type of transport vehicle, as mentioned. In other words, a dronepod cannot collide with a railpod or a trampod because they are all at different heights along the podway. Also, each podport knows the timing of all the active CNC[#]s that are assigned to use that podport. So, if say two pods on the same podway are within the specified distance or time delay of each other, then a collision is likely, and the trailing pod needs to be delayed or its speed along the podway needs to be slowed down. Slowing a pod down may be a more complex calculation than calculating a delay.

To calculate a delay, the trailing pod, if it is less than the minimum delay behind the lead pod, needs to be delayed from the lead pod by the minimum gap. For example, for two ETAs on different CNC[#]s, using the same type of transport vehicle, with a pre-determined gap less than the minimum, the delay needs to be increased to the minimum allowed. To avoid delaying a pod already on a podway, it may be easier and safer to delay the pod in the previous podport's exit bay, where the delay does not affect other pods. The delay is set in the previous PP, such that the delayed pod arrives at the merging PC or M the minimum gap time behind the leading pod, ensuring no collision can occur. The ETAs of the succeeding PPs, PCs and M along the route also need to be extended by the same amount. This delay calculation can be demonstrated using the example routes shown in FIGS. 17-20.

Each PP is given the xpod information such as time of starting the podway so that CNC system management can fit the xpod in with all the other xpods controlled by other CNCs in the same podway at a similar time.

FIG. 21 shows the three different routes, green, blue, and red, set up by 3 different CNC[#]s, CNC[1], [2], [3], through some of the same PPs, PCs, and Ms, at similar times, starting at PP[1], PP[2], PP[3] respectively. While setting up these journeys, each PP knows the PCs and markers along its hop between PPn and PPn+1, along with the heading of each podway, and ETA for each xpod at each marker.

Each time a new CNC is set up, the check is done and CNC[1] ETAs are checked with CNC[2] ETAs, then with CNC[3] ETAs. If only three CNCs, then CNC[2] ETAs are checked with CNC[3] ETAs. Then if a gap less than the minimum specified, say 10 seconds, is found, the preceding podport of the slower offending xpod, the xpod is delayed exiting the podport by the calculated amount, the succeeding hops need to be delayed by the same amount.

### CNC[#]s Calculate the Delays to Avoid Collisions

From FIGS. 21 and 22, the dronepod from PP[1] on the green route and the railpod from PP[2] on the blue route will arrive at M[2] at 9:26:11 and 9:26:20 respectively, just a few seconds apart. But because the dronepod is a few hundred feet above the railpod, there is no chance of a collision, so both continue on their routes.

For merging of xpods at markers or PCs, first check for the same consecutive markers/PCs in other CNC routes, then if any, check their ETAs at the matching markers. If a collision between two of the same transport types is likely, delay one xpod at the start of its previous PP, giving priority to requests for fastest. If no priorities, then delay the xpod most likely to arrive last. Plan for xpods to arrive a minimum gap time of say 10 seconds apart initially. For example, at 72 km/h=20 m/s(=45 mph) the trailing xpod will need a minimum of 200 m spacing between xpods. Any spacing shorter than 200 m requires the trailing xpod to delay starting from the previous PP until 10s after the leading xpod.

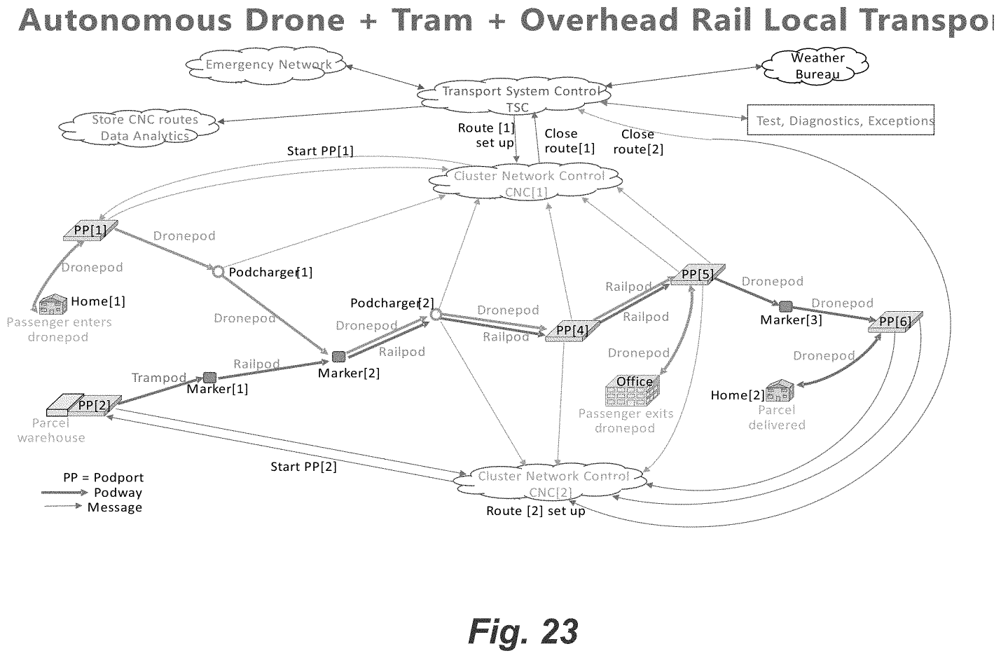

A possible solution for inserting a delay where needed is shown in FIG. 23. The roster of each CNC[#] is checked every time a new journey is submitted. In the example, the green route CNC[1] and then the blue route CNC[2] have been submitted and no delays were needed, refer to the table. Then the red route is submitted. The routine re-starts and checks the first entry of the green route, first making sure if there is in fact an entry. In this case there is an entry for PP[1]. Then it checks if the next column CNC[2] has an entry and because it does not it skips to Continue to the next entry down for CNC[2], checking if there is an entry. If there is, it checks if the transport type is the same as CNC[1]. Then if it is, it checks if the ETA of CNC[1] is less than 10 seconds earlier than the ETA of CNC[2]. If it is, it calculates the delay to be 10 seconds less the difference between the two ETAs. This delay also needs to be added to all the subsequent nodes along the route so that all the ETAs are updated. Then the next endway needs to be checked for CNC[1] and CNC[2], until all the endways for CNC[1] and [2] have been checked. Then CNC[2] is incremented to CNC[3] so that all CNC[1] and CNC[3] endways are checked. Then when the last endway of the last CNC{#} has been checked, CNC[2] has to be checked with CNC[3] etc.

In the routes, there is one combination where a delay is needed. This is for CNC[1] and CNC[3] at PC[1], where the transport is a dronepod and the ETAs are 9:33:36 and 9:33:30, a difference of 6 seconds, which is less than 10 seconds. A delay of 4 seconds is therefore inserted at PP[3] for CNC[1]. Then all subsequent ETAs need to be extended by 4 seconds all the way to the end, which is the office. The table is updated each time a new route is submitted, and each time a CNC is completed it is deleted from the table.

FIG. 23 is a comprehensive view of an overall proposed local transport system according to an embodiment of the invention. The system is managed by transport system control (TSC) that interfaces with various other data centers and multiple cluster network controllers. The other data centers include: a weather bureau that provides up to date local weather information for use when determining choice of route and transport vehicle; an emergency network that can determine why an exception is occurring and then resolving it; a data analytics unit that can store each completed route for future use and analysis; a test diagnostics unit that can regularly check the system and diagnose issues and monitor all parts of the whole system and attempt to fix problems; and possibly an entertainment system for passengers. TSC may also communicate with passengers that have problems.

TSC creates and deletes cluster network control modules, CNC[#], that control each route previously defined and agreed to by the passenger or parcel operator while setting up the journey. Each cluster control module manages its own route, with links to each selected podport and podcharger along the route. This enables each CNC to trigger the start of the journey, and to know the status of the pod as it exits each podport or podcharger along the route. It then indicates to TSC when the route has been completed. TSC may store the route's information for future use, and then it shuts down the module. Each podport is provided with the incoming pod's information and manages the transfer of the pod through the podport. The transporter comprises a pod attached to a transport vehicle which may be either an intelligent drone or chassis. The latter can operate as either a trampod, overhead railpod, or a carpod, depending on the track's grade or if it is a road. Also inside the podport, the carpod travels on a transfer path that charges the pod while traversing the podport. The transport vehicle is attached and detached to the pod while only in the podport and can not change vehicle type at a podcharger or a podway marker. But a trampod can become a railpod or carpod or the reverse sequence at a podcharger or podway marker, just by transferring from overhead rail to rail at grade or a road.

Podports are linked together by one or more podways, and the transporter follows the podways along the hop between podports. The transporters travel autonomously along the route, but also can detect other transporters of the same type merging on to the same podway and take necessary avoidance by delaying the trailing transporter. This can be minimized by pre-calculating the ETA of merging same transporter types and delaying the expected trailing one before it exits the previous podport.

The system supports both transport of passengers and parcels operating seamlessly and remaining in the same pod throughout the journey. It also ensures each pod has enough charge to reach the next podport, including the use of podchargers along the hop.

Thus the whole transport system supports passengers and parcels, multiple selectable transport types, unlimited journeys of any length, fast response, and easy upgradability.

In conclusion, a fairly complicated local transport system can be developed by upgrading from a simple parcel delivery system, allowing intermixing of drone transport, tramways, overhead rail and eventually carpods on legacy roads, transporting passengers, parcels, light goods, urgent mail, etc.

The skilled artisan will understand that the embodiments described in this disclosure are exemplary, and may be implemented in a variety of ways other than as explicitly detailed I these examples. The scope of the invention is limited only by the claims.

1. A transportation system, comprising:
a plurality of transport vehicles, each having controllable electric motors and a first attachment interface;
a plurality of pods, being enclosed compartments that can accommodate cargo, each pod having a door, a rechargeable battery, and a second attachment interface adapted to attach to the first attachment interface of an individual one of the transport vehicles;
a plurality of podports, being exchange stations adapted to attach to and detach pods from individual ones of the transport vehicles, individual ones of the podports located at specific locations in a specific geographic area;
a plurality of charging stations located at specific locations within the geographic area; and
a computerized transport control system;
characterized in that an authorized person communicates a request to the computerized transport control system to transport a specific cargo from a first location in the geographic area to a second location in the geographic area, the computerized transport control system in response defines a journey beginning at the first location and ending at the second location, the definition of the journey including a time for pickup of the specific cargo, a specific pod and transport vehicle assigned for pickup, and a route, the route comprising sequential hops through a series of podports and charging stations, the computerized transport control system managing movement of transport vehicles, exchanges at podports, and charging at charging stations along the defined route, the route ending at the second location where the cargo disembarks, wherein the computerized transport control system terminates the journey.

2. The transportation system of claim 1 wherein the cargo comprises passengers or parcels, or both passengers and parcels.

3. The transportation system of claim 1 wherein the plurality of transport vehicles comprises unmanned arial vehicles (UAVs) and transport chassis, the transport chassis adapted to travel on a roadway or on an overhead railway.

4. The transportation system of claim 1 wherein, in a journey, the pod is carried for a hop by a drone or by a transport chassis, and the pod is detached from one transport vehicle and attached to a different transport vehicle at individual ones of the podports in the journey.

5. The transportation system of claim 1 wherein the computerized transport control system creates a cluster network control (CNC) module unique to each defined journey, and the CNC controls the route for which it is created, retrieves status of the pod as the pod exits each podport and charging station along the route, and communicates completion of the journey to the computerized control system.

6. The transportation system of claim 1 wherein, with a pod attached to a transport vehicle, an electrical connection is implemented as well as a physical connection, and the electric motors of the transport vehicle are powered by the pod battery.

7. The transportation system of claim 6 wherein charging stations are adapted to charge the pod battery.

8. The transportation system of claim 1 wherein individual ones of the plurality of pods comprise an upper attachment interface adapted to attach to an attachment interface of an unmanned arial vehicle, to be suspended below the unmanned arial vehicle. and a lower attachment interface adapted to attach to an upper attachment interface of a transport chassis adapted to travel on a roadway or on an overhead railway.

9. The transportation system of claim 1 wherein, in the management of a journey the computerized transport control system communicates with remote data centers, comprising at least a weather bureau that provides up to date local weather information, an emergency center adapted to resolve exceptions, a data analytics center that is adapted to store each completed route for future use and analysis, and a test diagnostics unit adapted to check the system and to fix problems.

10. The transportation system of claim 5 wherein the CNC for a defined journey tracks the location of the pod, and as the pod approaches each podport in the journey, the podport is provided with information regarding the pod and the journey, and any defined exchange at the podport, and the podport manages movement of the pod through the podport.

11. A transportation method, comprising:
communicating a request by an authorized person to a computerized transport control system to transport a specific cargo from a first location in a geographic area to a second location in the geographic area;
defining a journey by the computerized transport control system in response to the request, the journey beginning at a first location in the geographic area and ending at a second location, the definition of the journey including a time for pickup of the specific cargo, a specific pod among a plurality of available pods, a pod being an enclosed compartment that can accommodate cargo, each pod having a door, a rechargeable battery, and a second attachment interface, and transport vehicle assigned for pickup among a plurality of available transport vehicles each having controllable electric motors and a first attachment interface, and a route, the route comprising sequential hops through a series of podports and charging stations, a podport being an exchange station adapted to attach to and detach pods from individual ones of the transport vehicles, individual ones of the podports located at specific locations in a specific geographic area;
managing by the computerized transport control system movement of the pod and transport vehicle during the journey, exchanges at podports, and charging at charging stations along the defined route; and
terminating the journey at the second location where the cargo disembarks.

12. The transportation method of claim 11 wherein the cargo comprises passengers or parcels, or both passengers and parcels, comprising moving the passengers and parcels or both along the route to the second location.

13. The transportation method of claim 11 wherein the plurality of transport vehicles comprises unmanned arial vehicles (UAVs) and transport chassis, the transport chassis adapted to travel on a roadway or on an overhead railway, comprising managing by the computerized transport control system the movement of the transport vehicle whether UAV of chassis.

14. The transportation method of claim 11 comprising, in a journey, carrying the pod for a hop by the UAV or by a the transport chassis, and detaching the pod from one transport vehicle and attaching the pod to a different transport vehicle at individual ones of the podports in the journey.

15. The transportation method of claim 11 wherein the computerized transport control system creates a cluster network control (CNC) module unique to each defined journey, comprising controlling the route by the CNC , retrieving status of the pod as the pod exits each podport and charging station along the route, and communicating completion of the journey to the computerized control system.

16. The transportation method of claim 11 comprising establishing an electrical connection as well as a physical connection when joining a pod to a transport vehicle, and driving the electric motors of the transport vehicle from the pod battery.

17. The transportation method of claim 16 comprising charging the pod battery by the charging stations.

18. The transportation method of claim 11 comprising attaching pods to UAVs by an upper attachment interface on the pad joining a lower attachment interface on the UAV, and attaching pods to transport chassis by a lower attachment interface on the pod to an upper attachment interface on the transport chassis.

19. The transportation method of claim 11 further comprising communicating by the computerized transport control system with remote data centers, the remote data centers comprising at least a weather bureau that provides up to date local weather information, an emergency center adapted to resolve exceptions, a data analytics center that is adapted to store each completed route for future use and analysis, and a test diagnostics unit adapted to check the system and to fix problems.

20. The transportation method of claim 15 comprising tracking location of the pod in a defined journey by the CNC, providing information regarding the pod and the journey to a podport as the pod approaches the podport, including any defined exchange at the podport, and managing movement of the pod through the podport.
